(19) United States
(12) Patent Application Publication
(10) Pub. No.: US 2010/0265618 A1
(43) Pub. Date: Oct. 21, 2010

(54) Method and Apparatus for Reducing Head Media Spacing in a Disk Drive

(76) Inventors: Zine-Eddine Boutaghou, North Oaks, MN (US); Karl Schwappach, North Oaks, MN (US)

Correspondence Address: Karl G Schwappach, 17 south Long Lake Trail, North Oaks, MN, 55127, US

(21) Appl. No.: 12/424,441

(22) Filed: Apr. 15, 2009

(51) Int. Cl. G11B 5/60

(52) U.S. Cl. 360/234.3; G9B/5.229

(57) ABSTRACT

Systems and methods for reducing head media spacing (HMS) from about 100 Angstroms to about 65 Angstroms or less, without substantial reductions in the carbon overcoat or lubricant thickness. A protruding feature extends above the actuated portion of the air bearing surface and generally covers the read-write sensors. The protruding feature can either be static or thermally actuated. The protruding feature is small enough to engage with the lubricant without causing large head media disturbances and lubricant pickup and re-distribution or preventing contact detection. The protruding feature is also extremely small relative to the size of the actuated portion of the air bearing surface, but large enough to provide a wear and corrosion resistance to head media spacing sensitive features.

### FIELD OF THE INVENTION

The present application is directed to a read-write head for a disk drive with a protruding feature on the air bearing surface adapted to penetrate into the lubricant while reliably performing read-write operations, thereby reducing head-media spacing (HMS).

### BACKGROUND OF THE INVENTION

The realization of a data density of 1 Terabyte/inch² (1 Tbit/in²) depends, in part, on designing a head-disk interface (HDI) with the smallest possible head-media spacing HMS. As used herein, “head-media spacing” or “HMS” refer to the distance between a read or write sensor and a surface of a magnetic media.

As illustrated in FIG. 1 the HMS 30 is the distance from magnetic media 32 to distal ends 34 of read-write sensors 36, 38. Shielding 64 is also commonly located near the read-write sensors 36, 38. Head-media spacing 30 is the sum of the clearance 40 and the spacing losses contributed by both the head 42 and the media 32. The passive clearance 40 provides a reliability buffer or safety factor between the air bearing surface 46 and surface 48 of the lubricant layer 50 to minimize head-media contact.

The head 42 contributes head carbon overcoat (HOC) 52, sensor recession (SR), slider waviness and roughness, and the thickness and roughness of the lubricant attached to the carbon overcoat 52. The media 32 contributes media carbon overcoat (MOC) 56, media waviness and roughness, the lubricant layer 50 and the roughness of the lubricant 58. FIG. 2 is a perspective view of the head 42 showing the location of the read-write sensors 36, 38 relative to the air bearing surface 46.

The carbon overcoat is constructed from a film of hard carbon called diamond-like carbon. As used herein, the phrases “diamond-like carbon” and “carbon overcoat” refer to a material that is chiefly made of carbon, has a tetrahedral and/or amorphous structure, and exhibits a hardness of the order of about 2×10⁹ to about 8×10¹⁰ Pa in Vickers hardness measurement. Further discussion of DLC can be found in U.S. Pat. No. 7,488,429, which is incorporated herein by reference. The lubricating layer is made of a variety of materials, such as for example PFPE (perfluoropolyether).

Conventional heads, such as illustrated in FIG. 1, typically include one or more heaters, such as for example heater 60 near to read head 36 and heater 62 near write head 38 to thermally expand a portion of the read-write head 42. Thermally induced expansion and contact detection are typically used during manufacturing of disk drives to establish the active clearance 41 (see FIG. 4) or slider flying height. “Contact detection” and “contact detection process” refer to bringing an actuated portion of an air bearing surface into contact with a lubricant layer, and then decreasing the actuation to an active clearance less than a passive clearance.

As illustrated in FIG. 3, one or more heaters 60, 62 move actuated portion 44 into contact with the surface 48 of the lubricant 50, such as for example by supplying current to one or more heaters 60, 62. Typically, only actuated portion 44 of the air bearing surface 46 in close proximity to the heaters 60, 62 engages with the lubricant 50.

The shape of the actuated portion 44 depends on a number of variables, such as for example the relative size and placement of the heaters 60, 62, the thickness and material from which the air bearing surface 46 is constructed, and the like. “Actuated portion” refers to a section or subset of the air bearing surface that is adapted to be expanded by actuators used during a contact detection process and/or during read-write sequences. For many embodiments, the actuated portion is in proximity to heaters used to thermally expand the air bearing surface. Since the actuated portion is a subset of the air bearing surface, reference to the air bearing surface by implication includes both the actuated portion and the un-actuated portion of the air bearing surface.

As illustrated in FIG. 4, the actuated portion 44 is then reduced, such as by reducing the current to the heaters 60, 62. The actuated portion 44 of the air bearing surface 46 retracts to establish an active clearance 41 or fly height of the head 42 above the lubricant layer 50, typically less than the passive clearance 40 illustrated in FIG. 1. As used herein, “clearance” refers to a minimum distance between an air bearing surface and a surface of a lubricant layer on a magnetic media. “Passive clearance” refers to the clearance before a contact detection procedure. “Active clearance” refers to the clearance after a contact detection procedure. Active clearance is typically measured from an actuated portion of the air bearing surface to the surface of the lubricant layer. The passive clearance is typically greater than the active clearance.

During read-write operations the actuated portion 44 typically remains thermally expanded above the primary portion of the air bearing surface. As illustrated in FIG. 4, the active clearance 41 is the distance from the actuated portion 44 of the air bearing surface 46 and the surface 48 of the lubricant 50.

Contact detection between the head and the media can be performed with a variety of methods including, position signal disturbance stemming from air bearing modulation, amplitude ratio and harmonic ratio calculations based on Wallace equations, and piezoelectric based acoustic emission sensors, such as disclosed in U.S. Pat. Publication 2009/0015962 (Daugela et al.). U.S. Pat. No. 7,440,220 (Kang et al.) takes advantage of a plateau in transducer spacing reached by actuating the expanding heater at the disk avalanche based on a read back signal. The plateau is interpreted as the point at which contact between the head and disk occurs, thus leveling of sensed magnetic signal improvement.

FIG. 5 illustrates the probable value of the passive clearance 40 (see FIG. 1) for a group of heads 42 before contact detection. Before contact detection a group of heads 42 typically exhibit a passive clearance 40 of about 100 Angstroms, with variability between about 70 Angstroms to about 130 Angstroms. As is illustrated in FIG. 5, there is only about a 4% chance that a particular head 42 will exhibit a passive clearance 40 of about 100 Angstroms. In the context of HMS, one standard deviation (one-sigma) corresponds to about 10 Angstroms. After contact detection the group of heads 42 exhibit an active clearance 41 (see FIG. 4) of about 20 Angstroms, with a variability of between about 10 Angstroms to about 30 Angstroms, where zero Angstroms corresponds with the surface 48 of the lubricant 50.

Manufacturing variability of the heads 42 creates the need to increase the active clearance 41 to reduce the chance of the head 42 impacting the carbon overcoat 56 and the lubricant 50. If this buffer or safety factor is reduced to decrease HMS, a larger percentage of the heads 42 will fail during manufacturing due to head modulation leading to signal degradation. A larger buffer increases HMS 30 so as to reduce data density. As the disk drive industry attempts to achieve a data density of 1 Tb/in² manufacturing yield of heads 42 has dropped to commercially unsustainable levels. Many in the industry believe that current disk drive designs have reached the limits of physics.

Total HMS can be calculated using the following equation:

HMS=HOC+MOC+Lubricant thickness+SR+Clearance+GA

A discussion of head and media roughness, also referred to as glide avalanche (GA), can be found in Mate et al., Will the Numbers Add Up for Sub-7-nm Magnetic Spacing?, Vol. 41, No. 2 IEEE Transactions on Magnetics 626 (2005). Glide avalanche accounts for the topographical contributions of the head and media including the lubricant roughness. Media waviness is discussed in Weimin et al., Disk Shape and Its Effect on Flyability, Vol. 39, No. 2 IEEE Transactions on Magnetics 735-739 (2003). Thickness and roughness of lubricant attached to head and media is discussed in Mate et al., Roughness of Thin Perfluoropolyether Lubricant Films: Influence on Disk Drive Technology, Vol. 37, No. 4 IEEE Transactions on Magnetics 1821-1823 (July 2001).

The current practice is to apply a relatively thick carbon overcoat 52, 56 to both the read-write sensors 36, 38 and the magnetic media 32 that offers both corrosion protection and wear durability. The read-write sensors 36, 38 are typically protected by a carbon overcoat 52 about 20-30 Angstroms thick (1 Angstrom=1×10⁻¹⁰ meters). The head 42 is typically maintained in the active clearance 41 (see FIG. 4) of about 20-30 Angstroms above the surface 48 of the lubricant layer 50. The lubricant layer 50 typically has a thickness of about 12-15 Angstroms. Finally, about 25 to about 35 Angstroms of carbon overcoat 56 protects the magnetic media 32. Consequently, prior art HMS 50 averages about 95 Angstroms to about 105 Angstroms. Liu et al., Towards Fly- and Lubricant-Contact Recording, 320 Journal of Magnetism and Magnetic Materials 3183 (2008).

For data densities in the 1 Tb/in² range the HMS 30 will need to be reduced to about 60 Angstroms to about 65 Angstroms (see, R. Wood, The Feasibility Of Magnetic Recording At 1 Terabit Per Square Inch, Vol. 36 IEEE Transactions on Magnetics 716-721 (2000)). At this HMS level, however, head-lubricant interaction will have an increasingly stronger impact on read-write performance (see, X. Ma et al., Contribution Of Lubricant Thickness To Head-Media Spacing, Vol. 37, No. 4 IEEE Transactions on Magnetics 1824-1826, (2001)). The head-lubricant interaction creates large interfacial and shear forces that displaces the lubricant and causes lubricant moguls and washboard effects that lead to vibration of the head. Such a lubricant displacement becomes more pronounced with reduction of head media spacing.

When the slider comes within about 10 Angstroms of the disk surface, a substantial attractive or adhesive force pulls down on the part of the slider closest to the disk surface, collapsing the air bearing. This adhesive force can arise from a combination of sources, including Van der Waals interactions between the slider and disk, chemical bonding across the contacting interface, electrostatic forces from a bias voltage on either the slider or disk, such as caused by disk drive spindle motor charging or intentional application, electrostatic forces from the slider-disk contact potential, electrostatic forces from charges generated by rubbing the slider against the disk (tribocharging), and meniscus forces from lubricant or contaminant wicking up around the contact points.

Dynamic effects of lubricant displacement from shear effect of low flying sliders have been observed (See, Q. Dai et al., Washboard Effect at Head-Disk Interface, Vol. 40, No. 4 IEEE Transactions on Magnetics 3159-3161 and successfully modeled (B. Marchon et al., The Physics of Disk Lubricant in the Continuum Picture, Vol. 41, No. 2 IEEE Transactions on Magnetics (2005). These dynamic effects are responsible for loss of necessary slider/disk clearance, tracking errors, and reduced reliability.

The head-lubricant interfacial meniscus force have been quantified by K. Ono, Dynamic Instability of Flying Head Slider and Stabilizing Design for Near Contact Magnetic Recording, No. 320 Journal of Magnetism and Magnetic Materials 3174-3182, (2008) according to the following formula:

F=2gA/h

where g is the surface tension of the lubricant, h is the clearance, and A is the total surface area of engagement with the lubricant. A typical interface with the following characteristics: g is about 22 microNewton meters; h is about 25 Angstroms; A is about 1,000 microns² (10 microns×100 microns) creates an interfacial force of about 1760 mN. As the spacing (h) is reduced toward zero, even more lubricant is displaced and the force F quickly increaseS, causing head vibration and off-track movement degrade read-write performance to an unacceptable level.

If the interfacial lubricant forces exceed the air bearing forces, the slider body may be pulled further into the lubricant leading to contact modulation with the media and inhibiting the read and write operations. Care must be taken to ensure that the interfacial forces never exceed the lift forces provided by the air bearing under all environmental and operating conditions. K. Ono, Dynamic Instability of Flying Head Slider and Stabilizing Design for Near-Contact Magnetic Recording, 320 Journal of Magnetic Materials and Magnetism 3174-3182 (2008) warns that lubricant-head contact leading to instantaneous lubricant interfacial forces collapsing the air bearing performance and should be avoided.

With this background in the physics of HMS, the limitations in the existing solutions will become evident.

U.S. Pat. No. 6,320,725 (Payne) discloses a contact recording system with a wear-in contact pad. During a burn-in phase, the wear-in contact pad is burnished until it reaches an equilibrium and the wear rate converges to zero. Mechanical tolerances cause the contact pad to not sit flat with respect to the disk. The critical read-write sensors may be tilted impeding the read-write performance. Mechanical vibrations and bouncing is experienced due to disk run-out and waviness, causing the contact pad to bounce and leading to impractically large head media spacing fluctuations. The burn-in phase causes the protective overcoat to burnish, potentially exposing the read-write sensors to corrosion and causing mechanical and magnetic degradation. The strategy of Payne is not viable for modern head disk interfaces requiring sub-nanometer modulations and corrosion protection.

U.S. Pat. No. 7,029,590 (Alexopoulos et al.) reasons that as disk drive fly heights are getting closer to the disk to increase areal density, the ultimate fly height goal will be to put the element in contact with the disk media, thus reducing the fly height to zero. However in practice, a reliable contact interface is very difficult to achieve due to the wear of the head and disk, resulting in early failure when compared to higher fly heights with a cushion of air between them. The reliability problem is exacerbated by manufacturing tolerances which results in significant variation in the amount of interference in the contact interface.

Alexopoulos' approaches the above-described problems by fabricating a wearable pad surrounding the transducer so that the protruding element has a height that is greater than or equal to the designed fly height of the aerodynamic lift surface minus the disk roughness. See FIG. 6. The wearable pad of Alexopoulos initially needs to be longer than the active clearance plus the lubricant thickness in order to contact the disk. Consequently, the wearable pad of Alexopoulos blocks the use of a contact detection process. Since the actual location of the read-write sensors in the head is subject to manufacturing variability, the inability to perform a contact detection process means that the solution of Alexopoulos is unable to accurately determine sensor location and HMS. It is estimated that the wearable pad needs to be about 50-60 Angstroms in a conventional disk drive application. When the portion of HMS attributable to the media is also added, the solution of Alexopoulos is unlikely to achieve the HMS necessary to support a data densities of 1 Tbit/in².

U.S. Pat. Publication No. 2008/0080094 (Tani et al.) discloses a magnetic head slider with an element pad containing the read-write sensors. Tani teaches that the element pad requires a height in ranges from 50 Angstroms to 300 Angstroms. As with Alexopoulos, the height of the element pad in Tani is greater than the thickness of the lubricant layer on current magnetic disks. Consequently, it is not possible to bring the air bearing surface into contact with the lubricant layer to perform contact detection. Hence, the solution of Tani is unable to accurately determine sensor location and HMS. U.S. Pat. Publication No. 2005/0213250 (Kurita et al.) suffers from the same shortcomings as Tani et al.

U.S. Pat. No. 6,914,752 (Albrecht et al.) proposed continuous contact recording with a head-suspension assembly that compensates for the moment generated from an adhesive force between the head carrier or slider and the disk. The lubricant interaction with the contact pad can cause large off-track motions. Uncontrolled wear and interference between the contact pad and the disk lead to variations in read-write sensor height. Removal of the protective overcoat leads to generation of oxide layers that is susceptible to further degradation at high temperatures and high humidity.

U.S. Pat. No. 7,218,478 (Mate et al.) proposes a negative-pitch slider in near-contact or continuous-contact with the disk during reading and writing of data. In near contact recording the slider will be in contact with the rotating disk during a significant portion of the time the disk is at its operating speed. For continuous-contact recording the contact pad is wear-resistant and remains in substantially continuous contact with the disk during reading and writing of data. Direct contact at the head disk interface with the media can burnish and corrode the read-write sensors, leading to the same shortcomings found in Albrecht et al. (U.S. Pat. No. 6,914,752).

U.S. Pat. Publication 2007/0253111 (Shimizu et al.) discloses a read element and a write element of a magnetic head slider arranged on a spherical or ellipsoidal projection formed in the alumina. Manufacturing processes, however, are presently not able to easily fabricate three dimensional shapes, such as the proposed spherical pad. The spherical shape also creates a point contact that causes large stresses at the read-write sensors, increasing wear on the relatively soft alumina. Once the spherical pad starts wearing, a flat surface forms with the potential of increasing interfacial meniscus forces with the lubricant, especially in close proximity with media where the lubricant bridges to the head via the burnished surface. Controlling the attitude of the flying head is critical to assure that the transducers are located at the center of the contacting spherical pad. Geometrical tolerances impact the attitude of the flying slider, thus changing the location of the transducers relative to the media, translating to higher HMS.

As summarized above, the generalized wear-in pad and contact recording concepts suffer from the fundamental limitation of uncontrolled burnishing, protective overcoat burnish, and loss of mechanical and magnetic performance.

U.S. Pat. No. 5,991,113 (Meyer et al.) and U.S. Publication No. 2006/0285248 (Pust et al.) disclose a thermally expansive electric coil embedded in the trailing edge of the slider used to perform a contact detection process. During thermally induced expansion of the trailing edge, the transducer spacing with respect to the disk decreases until the slider penetrates the lubricant and contacts the media. The heat is then reduced to increase the flying height above the lubricant to the desired active clearance.

Mate M. et al., Roughness of Thin Perfluoropoyether Lubricant Films: Influence on Disk Drive Technology, Vol. 37 IEEE Transactions on Magnetics, No. 4 (July 2001) discloses that the head-lubricant interaction during contact detection causes head modulation and head-off track motion, leading to wear and burnish of the head and media overcoats. Contact between heads and media has two distinct consequences. First, the lubricant is displaced and forms ripples under the flying head. This washboard effect can cause increased fly height modulation as summarized in Dai Qing, et al., Washboard Effect at Head-Disk Interface, Vol. 40, No. 4 IEEE Transactions on Magnetics 3159-3161, (July 2004). Second, the carbon overcoat is burnished from the head disk interface, causing loss of magnetic performance at either the read or write sensors.

Bo et al., Towards Fly- and Lubricant-Contact Recording, Vol. 320, Journal of Magnetism and Magnetic Materials 3128-3133 (November 2008), proposes shaping a center pad on the slider to ski over the lubricant layer. It is proposed that fabrication of a rounded surface to promote hydrodynamic lift at the lubricant layer will reduce HMS. The fact that the lubricant thickness is not uniform increases the required peak pressure at the skiing pad. Waviness of the media in both short and long wavelengths challenges the flying ability of the skiing pad.

Song et al U.S. Pat. Nos. 7,428,124 and 7,430,098 (Song, et al.) disclose various arrangements of single and multiple heaters and thermal insulation layers to generate a relatively flat protruding profile on the trailing edge of the slider. Uniform deformation of the trailing edge leads to constant HMS for both read and write operations. The methodology presented is desirable for enhancing the contact area, but at the expense of modulation due to lubricant interactions with the large, albeit relatively flat, contact area.

U.S. Pat. No. 7,388,726 (McKenzie et al.) discloses control schemes for controlling the heater to dynamically adjust HMS. In one embodiment, a controller directs electrical current through the conductor to heat the write element without writing data to a storage disk. Heating the write element causes a deformation of the slider assembly to decrease the head-to-disk spacing. In another embodiment, the slider assembly includes a separate slider deformer.

U.S. Pat. Publication No. 2007/0035881 (Burbank et al.) discloses the use of a dual heater design, illustrated in FIGS. 7 and 8. The primary heater displaces a large area of the slider body to cause contact detection while the secondary heater displaces a second portion of the slider body. The power required to displace the concentrated protrusion is about the same order of magnitude as the primary heater or larger, depending on the electrical resistance and location of the secondary heater. K. Miyake et al., Optimized Design of Heaters for Flying Height Adjustment to Preserve Performance and Reliability, Vol. 43, No. 6 IEEE Transactions on Magnetics 2235-2237 (2007) gives an overview of the tradeoffs between heater location and size and its impact on the temperature rise due to heater actuation. Such concentrated protrusions using current limitations of heater designs and materials are not physically practical without causing material diffusion, melt down of the conductors, or excessive temperatures at the head disk interface. As taught in U.S. Pat. Publication No. 2005/0213250 (Kurita et al.), the life of the read-write heads is shortened when exposed to high temperature for long periods of time. Even though the shape of the protruded area in Burbank is concentrated proximate to the writer, practical and physical limitation of thermal diffusion and protrusion shape dictates a relatively large protrusion area that will cause a significant interfacial force at the onset of lubricant interaction.

### BRIEF SUMMARY OF THE INVENTION

The present invention relates to systems and methods for reducing head media spacing (HMS) from about 100 Angstroms to about 65 Angstroms or less, without substantial reductions in the carbon overcoat or lubricant thickness. A HMS of about 65 Angstroms will enable to disk drive industry to achieve a data density of 1 Terabyte/inch² (1 Tbit/in²) with minor engineering design changes to the current air bearing and heater implementations.

The present system makes it possible to reduce HMS through the use of a protruding feature on an actuated portion of the air bearing surface. The protruding feature preferably covers the entire read-write sensors. A distal end of the protruding feature extends above the actuated portion of the air bearing surface during read-write operations. The protruding feature can either be static or thermally actuated. The protruding feature is preferably constructed from the same material as the protective overcoat, such as diamond-like carbon.

During the contact detection process, the protruding feature preferably has a height above the actuated portion of the air bearing surface of less than or equal to the thickness of the lubricant layer. Consequently, the protruding feature does not prevent the actuated portion of the air bearing surface from interacting with the lubricant layer. In another embodiment, the protruding feature has a height above the air bearing surface during read-write operations of less than the active clearance, typically less than about 50 Angstroms, and preferably about 30 Angstroms to about 20 Angstroms.

The protruding feature is small enough to engage with the lubricant without causing large head media disturbances and lubricant pickup and re-distribution. The protruding feature is also extremely small relative to the size of the air bearing surface. Consequently, a stable air bearing is maintained, even when the protruding feature penetrates into the lubricant.

For example, a typical actuated portion of the air bearing surface is about 100 microns by about 10 microns, or about 1,000 microns². The protruding feature according to the present invention is preferably less than about 100 microns², and more preferably less than about 50 microns². In another embodiment, the protruding feature is less than about 10 microns², more preferably about 1 microns². The distal surface of the protruding feature is preferably less than about 5% of a surface area of the actuated portion of the air bearing surface, and more preferably less than about 1%, and still more preferably less than about 0.1%. The protruding feature can have a cross-sectional that is rectangular, elliptical, triangular, teardrop, or random. The size of the protruding feature minimizes the transfer of lubricant to the head, generates acceptably low off-track motion, and minimizes temperature increases at the head-disk interface.

Thick carbon overcoat tends to be denser and provide better wear protection than thin carbon overcoat layers when exposed to the same level of stress. To provide a more robust protruding feature it may be desirable to initially start with a thick carbon overcoat layer and allow it to burnish to its natural state. Note that care must be taken to allow the final carbon overcoat thickness after burnish to be capable of providing wear protection against media defects and interactions. Therefore, in some embodiments, it may be desirable for the protruding feature before the contact detection process to have a height slightly greater than the thickness of the lubricant layer. After completing the various test processes and the contact detection process, the height of the protruding feature will naturally converge to less than or equal to the lubricant thickness. In this embodiment, the height of the protruding feature is preferably less than about 25% greater than the thickness of the lubricant layer. Alternatively, the height of the protruding feature is preferably less than about five Angstroms more than the thickness of the lubricant layer.

The typical read-write sensors have a cross-section of about 0.1 microns by about 0.1 microns (0.01 microns²). Even in embodiments where the protruding feature has a cross section of about 1 micron², the protruding feature still has a cross-sectional area 100 times larger than the read-write sensors. Consequently, the protruding feature provides adequate corrosion and wear protection, while still being small enough to penetrate the lubricant layer without generating unacceptable vibration.

In some embodiments, the protruding feature can be shaped to further reduce modulation due to interaction with the lubricant. For example, the protruding feature can have a rectangular cross-section, rather than square. In one embodiment, the narrower side of a rectangular protruding feature acts as a leading edge cutting through the lubricant. The shape of the protruding feature can be rectangular, elliptical, triangular, teardrop, or a random shape to further lower the interfacial forces with the lubricant and optimize the clearance of the heat activated shape. The shape of the protruding feature can also be designed to match the shape of the protruded trailing edge area due to heating. The most likely scenario is an elliptical shape.

During contact detection heat is applied to the head until contact is detected by the interactions of the actuated portion of the air bearing surface with the surface of the lubricant. The distal surfaces of the protruding features are very small, causing no practical interfacial lubricant interactions, even during lubricant penetration. To avoid burnishing of the protruding features, the air bearing must be capable of following the disk waviness of the magnetic media.

In embodiments where the height of the protruding features is equal or smaller than the thickness of the lubricant and the air bearing is adequate to follow the waviness of the magnetic media, burnishing of the protruding features is minimized. In this embodiment, the safety margin designed into the carbon overcoat thickness on the head and the magnetic media can be reduced, with a corresponding reduction in HMS.

One embodiment of the present invention is directed to a slider for use in a data storage system having a rotating magnetic media with a lubricant layer on a media surface. A slider body includes at least one read-write sensor and an air bearing surface that causes the slider to fly above a lubricant surface at a first distance. At least a first actuator induces thermal expansion in the slider body so an actuated portion of the air bearing surface contacts the lubricant surface during a contact detection process. The slider flies above the lubricant surface at a second distance less than the first distance after the contact detection process. At least one protruding feature generally covers the read-write sensors. The protruding feature includes a distal surface generally opposite the media surface with an area of less than about 100 microns² and a height above the air bearing surface after the contact detection process less than or equal to a thickness of the lubricant layer.

In an alternate embodiment, the protruding feature has a height before the contact detection process greater than the lubricant thickness, but less than or equal to the lubricant thickness after the contact detection process. In one embodiment, the protruding feature has a height above the air bearing surface before the contact detection process less than about 25% greater than the thickness of the lubricant layer. The protruding feature typically has a height above the air bearing surface before the contact detection process of less than about 30 Angstroms to about 10 Angstroms.

In one embodiment, at least one secondary actuator is provided to induce thermal expansion of the protruding feature, without substantial thermal deformation of the air bearing surface adjacent to the protruding feature. Some embodiments provide a recessed actuated portion of the air bearing surface to minimize the impact of the secondary actuators on active clearance.

In another embodiment, a distal end of the read-write sensor is preferably located at or above the actuated portion of the air bearing surface before activation of the secondary actuator. In yet another embodiment, the distal end of the read-write sensor is located at or above the actuated portion after activation of the secondary actuator. The HMS is preferably less than about 65 Angstroms, and more preferably less than 55 Angstroms after activation of the secondary actuator.

At least one pressure relief is optionally located proximate the protruding feature. In one embodiment, the pressure relief is located between the protruding feature and the actuated portion of the air bearing surface. The pressure relief is optionally a generally circular or generally elliptical cross-sectional recess. A separate pressure relief can be located around the read sensor and the write sensor, or a single pressure relief can extend around both. In one embodiment, the actuated portion of the air bearing surface is also recessed relative to the remainder of the air bearing surface.

The present invention is also directed to a slider for use in a data storage system having a rotating magnetic media with a lubricant layer on a media surface. A slider body includes at least one read-write sensor and an air bearing surface that causes the slider to fly above a lubricant surface at a first distance. At least a first actuator induces thermal expansion in the slider body so an actuated portion of the air bearing surface contacts the lubricant surface during a contact detection process. The slider flies above the lubricant surface at a second distance less than the first distance after the contact detection process. At least one protruding feature generally covers the read-write sensors. The protruding feature has a height above the air bearing surface after the contact detection process less than or equal to a thickness of the lubricant layer. The signal modulation from the read-write sensors is less than 20% after the contact detection process, even when the protruding feature engages with the lubricant layer on the rotating magnetic media.

The present invention is also directed to a slider for use in a data storage system having a rotating magnetic media with a lubricant layer on a media surface. A slider body includes at least one read-write sensor and an air bearing surface that causes the slider to fly above a lubricant surface at a first distance. At least a first actuator induces thermal expansion in the slider body so an actuated portion of the air bearing surface contacts the lubricant surface during a contact detection process. The slider flies above the lubricant surface at a second distance less than the first distance after the contact detection process. At least one protruding feature generally covers the read-write sensors. The protruding feature has a height above the air bearing surface after the contact detection process less than or equal to a thickness of the lubricant layer. Air provides a reliability buffer between the air bearing surface and the surface of the lubricant. Air and lubricant provide a reliability buffer between the protruding feature and the media surface.

The present invention is also directed to a data storage system including a rotating magnetic media with a lubricant layer on a media surface. A slider body with at least one read-write sensor and an air bearing surface flies above a lubricant surface at a first distance. At least a first actuator thermally induces expansion in the slider body so an actuated portion of the air bearing surface contacts the lubricant surface during a contact detection process. The slider flies above the lubricant surface at a second distance less than the first distance after the contact detection process. At least one protruding feature generally covers the read-write sensors. The protruding feature includes a distal surface generally opposite the media surface with an area of less than about 100 microns² and a height above the air bearing surface after the contact detection process less than or equal to a thickness of the lubricant layer.

In one embodiment, at least one secondary actuator thermally induces expansion of the protruding feature, without substantial thermal deformation of the air bearing surface adjacent to the protruding feature. The resulting HMS is preferably less than about 65 Angstroms, and more preferably less than 55 Angstroms after activation of the secondary actuator.

The present invention is also directed to a method for use in a data storage system. The method includes locating a slider body having at least one read-write sensor above a rotating magnetic media. The slider body includes at least one protruding feature generally covering the read-write sensors. An air bearing is generated that causes the slider to fly above a lubricant surface at a first distance. The slider body is thermally expanded so a actuated portion on an air bearing surface contacts the lubricant surface during a contact detection process and the at least one protruding feature penetrates the lubricant layer. The thermal expansion of the slider body is reduced after the contact detection process so the slider flies above the lubricant surface at a second distance less than the first distance, and the protruding feature comprising height above the air bearing surface after the contact detection process less than or equal to a thickness of the lubricant layer. Data is then written to the magnetic media.

The present method optionally includes the step of activating at least one secondary actuator to induce thermal expansion of the protruding feature without substantial thermal deformation of the air bearing surface adjacent to the protruding feature. In one embodiment, thermal expansion of the slider body is reduced to compensate for a decrease in the second distance caused by activating the secondary heater.

The position of the read sensor and the write sensor relative to the plane of the air bearing surface typically varies from head to head. For example, due to differential lapping removal and etch removal rates during the manufacturing processes, the read sensor and writer sensor may have different recessions with respect to the air bearing surface. Also, increasing the air bearing pitch (i.e., the pitch of the slider relative to the magnetic media) will lead to a higher clearance for the read sensor than to the write sensor. Heater design can also lead to variability in the shape of the protruding feature, which leads to different clearance between the read and write sensors during the active clearance settings. Consequently, active clearance for the read sensor may be different than the active clearances for the write sensor, both in terms of mean and sigma. To maximize reliability it is possible to provide different carbon overcoat thickness for the read sensor and the write sensor. For purposes of simplicity, however, this disclosure presents the carbon overcoat thickness as constant for the read sensor and the write sensor.

By way of example only, the following tolerance illustrates the points noted above. For example, lubricant thickness is about 15 Angstrom, the sensor recession is about −3 Angstrom for reader and about −2 Angstrom for writer with respect to contact features, and sensor location with respect to the lubricant during contact detection is about 5 Angstrom above lubricant for reader and about 0 Angstrom above lubricant for writer. This simple example demonstrates that the required carbon overcoat on the protruding feature is about 23 Angstrom (15+3+5) and for the writer about 17 Angstrom (15+2+0). To maximize the reliability it is recommended to create a protruding feature about 23 Angstroms above the air bearing surface.

The contact detection process will naturally burnish the protruding feature on the write sensor from about 23 Angstrom to about 17 Angstrom, while not burnishing the protruding feature deposited on the read sensor. Another possibility would be to deposit about 23 Angstroms on the read sensor and about 17 Angstroms on the write sensor, without the need for burnish during contact detection. For purposes of illustration and simplicity this disclosure presents the read sensor and the write sensor in the same reference plane during contact detection with the lubricant.

### BRIEF DESCRIPTION OF THE SEVERAL VIEWS OF THE DRAWING

FIG. 1 is a schematic side sectional view of HMS in prior art disk drives

FIG. 2 is a schematic perspective view of the head of FIG. 1.

FIG. 3 is a graphical illustration of probable clearance in the prior art disk drive of FIG. 1.

FIG. 4 illustrates the HMS of the disk drive of FIG. 1 during a contact detection process.

FIG. 5 illustrates the HMS of the disk drive of FIG. 1 after the contact detection process.

FIG. 6 is a prior art non-actuatable wear pad at the trailing edge of the air bearing.

FIGS. 7 and 8 illustrate a prior art dual heater system design.

FIG. 9A is a schematic illustration of a head with a protruding feature in accordance with an embodiment of the present invention.

FIG. 9B is a perspective view of the head of FIG. 9A.

FIG. 9C is a graph of the probably clearance for the head of FIG. 9A before and after contact detection.

FIG. 9D is a schematic illustration of a head with a protruding feature before and after contact detection in accordance with an embodiment of the present invention.

FIG. 9E is a perspective view of the head of FIG. 9A.

FIG. 9F is a schematic illustrated of the head of FIG. 9A after completing the contact detection process.

FIG. 9G is a perspective view of a disk drive incorporating the head of FIG. 9A.

FIG. 10A is a schematic illustration of a head with two protruding features in accordance with an embodiment of the present invention.

FIG. 10B is a perspective view of the head of FIG. 10A.

FIG. 10C is a schematic illustration of an alternate heads with a recesses actuated portion of an air bearing surface surrounding a protruding feature in accordance with an embodiment of the present invention.

FIG. 11 is a schematic illustration of an alternate head with protruding features in accordance with an embodiment of the present invention.

FIG. 12 is a schematic illustration of another alternate head with protruding features in accordance with an embodiment of the present invention.

FIG. 13A is a schematic illustration of another alternate head with a protruding feature surrounded by a pressure relief in accordance with an embodiment of the present invention.

FIG. 13B is a perspective view of the head of FIG. 13A.

FIG. 13C is a schematic illustration of the head of FIG. 13A both before and after contact detection.

FIG. 13D is a three-dimensional view of the protruding feature of the head of FIG. 13A.

FIG. 13E is a schematic illustration of the head of FIG. 13A with the secondary heater activating the protruding feature in accordance with an embodiment of the present invention.

FIG. 13F is a three-dimensional view of the protruding feature of the head of FIG. 13E with the secondary heater activated.

FIG. 13G is a graph of the probably clearance for the head of FIG. 13A.

FIG. 14A is a schematic illustration of alternate head with two protruding features surrounded by pressure reliefs in accordance with an embodiment of the present invention.

FIG. 14B is a perspective view of the head of FIG. 14A.

FIG. 15A is a schematic illustration of another alternate head with a protruding feature in accordance with an embodiment of the present invention.

FIG. 15B is a perspective view of the head of FIG. 15A.

FIG. 15C is a schematic illustration of the head of FIG. 15A both before and after contact detection.

FIG. 15D is a three-dimensional view of the protruding feature of the head of FIG. 15A.

FIG. 15E is a schematic illustration of the head of FIG. 15A with the secondary heater activating the protruding feature in accordance with an embodiment of the present invention.

FIG. 15F is a three-dimensional view of the protruding feature of the head of FIG. 15E with the secondary heater activated.

FIG. 15G is a graph of the probably clearance for the head of FIG. 15A.

FIG. 15H is a schematic illustration of an alternate heads with a recesses actuated portion of an air bearing surface surrounding a protruding feature in accordance with an embodiment of the present invention.

FIG. 16A is a schematic illustration of another alternate head with a protruding feature in accordance with an embodiment of the present invention.

FIG. 16B is a schematic illustration of the head of FIG. 16A with a heater activating the protruding feature in accordance with an embodiment of the present invention.

FIG. 17A is a schematic illustration of another alternate head with a stepped protruding feature in accordance with an embodiment of the present invention.

FIG. 17B is a schematic illustration of the head of FIG. 17A with a heater activating the protruding feature in accordance with an embodiment of the present invention.

### DETAILED DESCRIPTION OF THE INVENTION

The systems and methods disclosed herein reduces the current HMS of about 100 Angstroms to about 65 Angstroms or less, without substantial carbon overcoat reductions or lubricant reduction. This reduction in HMS will enable the industry to achieve 1 Tbit/in² with minor engineering design changes to the current air bearing and heater implementations.

While the prior art typically relied on the indiscriminate application of carbon overcoat to protect both sensitive and non-critical area, the embodiments disclosed herein selectively retain carbon overcoat in critical areas to protect the transducer areas against corrosion and wear.

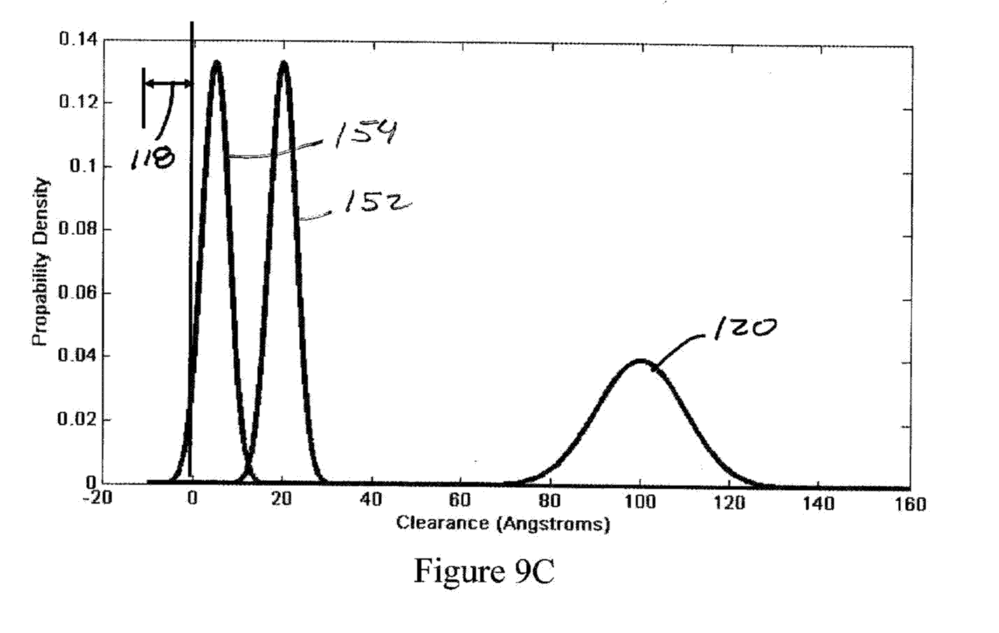

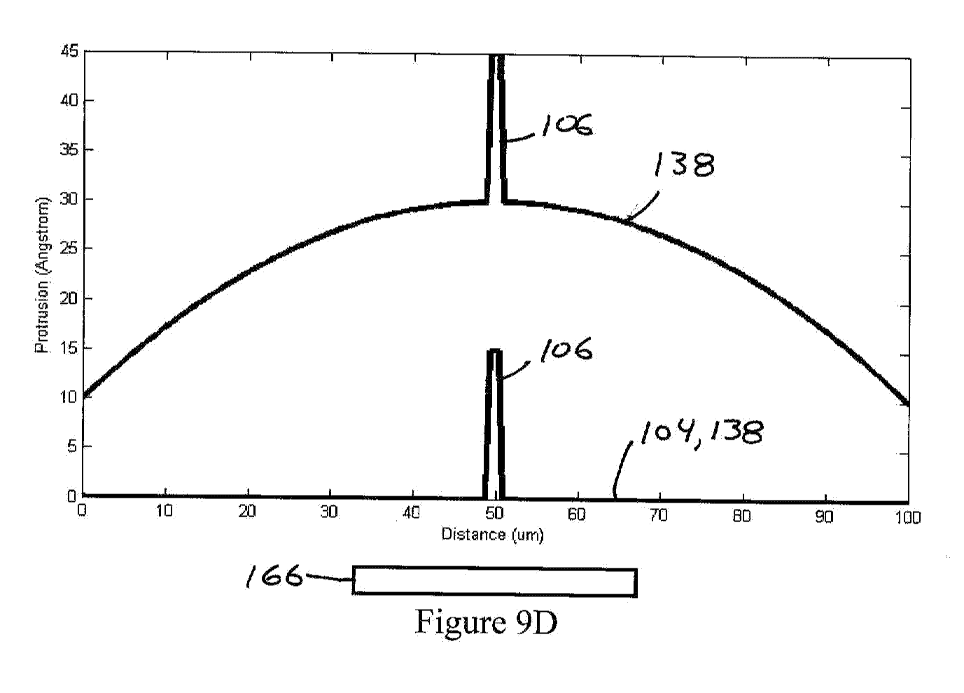

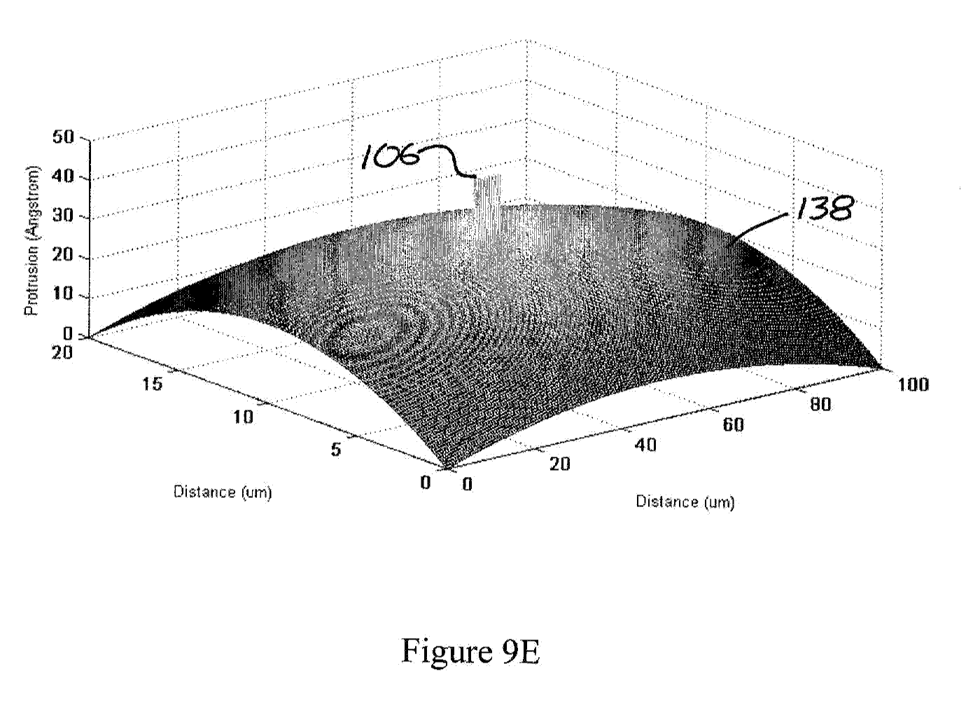

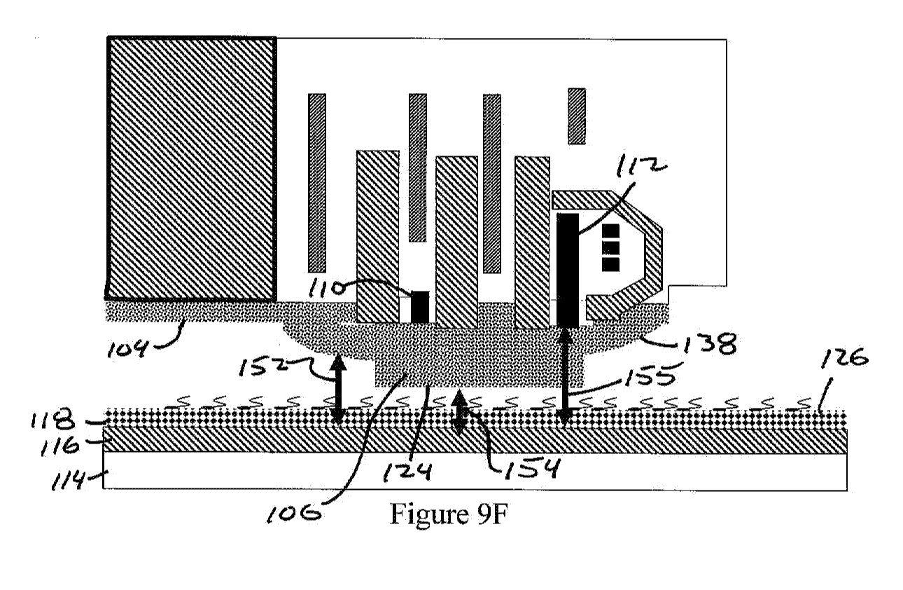

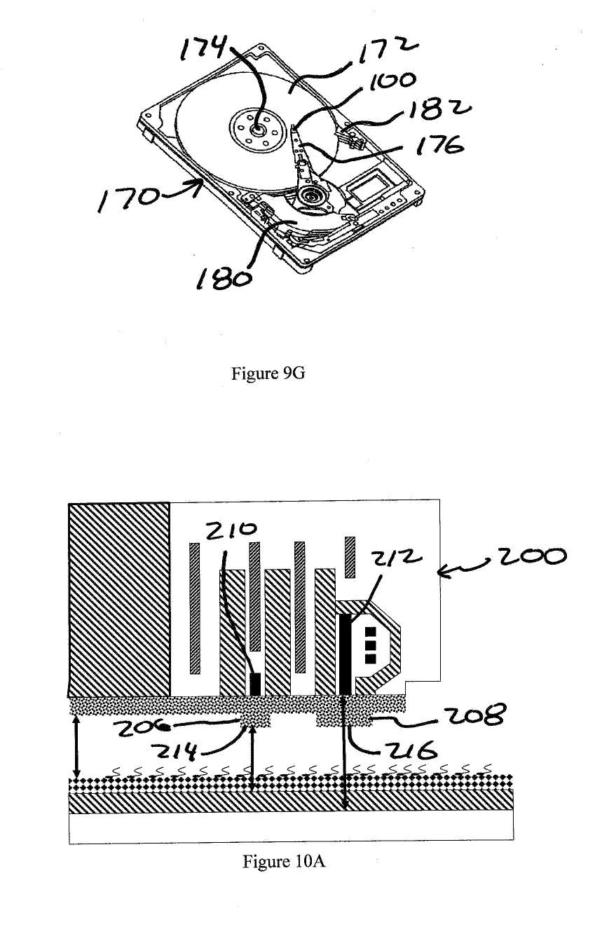

FIGS. 9A and 9B illustrate an alternate read-write head 100 in accordance with an embodiment of the present invention. Thickness of the carbon overcoat 102 is reduced across the air bearing surface 104, except for protruding feature 106 protecting read-write sensors 110, 112. Since the requirement of wear durability is more stringent than corrosion protection, the protruding feature 106 provides sufficient wear durability to protect the read-write sensors 110, 112. As used herein, “read-write sensors” refers to one or more of the return pole, the write pole, the read sensor, magnetic shields, and any other components that are spacing sensitive.

The protruding feature 106 is fabricated at the trailing edge of the read-write head 100. The protruding feature 106 is typically formed from portions of the read-write sensors 110, 112, the alumina, and/or the diamond-like carbon overcoat 102. In one embodiment, the entire protruding feature 106 is constructed entirely from diamond-like carbon, with or without portions of the read-write sensors 110, 112.

In one embodiment, the protruding feature 106 has a height 108 above the air bearing surface 104 before completing the contact detection process of about the same as lubricant 118 thickness. In another embodiment, the protruding feature 106 has a height 108 before the contact detection process greater than the thickness of the lubricant 118. During the contact detection process the height 108 of the protruding feature 106 is burnished to less than or equal to the thickness of the lubricant 118. Consequently, the protruding feature 106 does not prevent or interfere with the contact detection process. In this embodiment, the protruding feature 106 has a height 108 above the air bearing surface 104 before the contact detection process less than about 25% greater than the thickness of the lubricant layer 118. The protruding feature 106 typically has a height above the air bearing surface 104 before the contact detection process of less than about 30 Angstroms to about 10 Angstroms.

The read-write sensors 110, 112 typically have surface areas 130, 132 opposite the magnetic media 114 typically less than about 0.1 micron×about 0.1 micron. Distal surfaces 124 of the protruding feature 106 is preferably less than about 100 microns². Consequently, the distal surface 124 of the protruding feature 106 is about 5,000 times larger than the combined surfaces 130, 132 of the read-write sensors 110, 112 (100 microns/0.02 microns=5,000). An oxygen molecule must travel through both the carbon overcoat 102 and the thickness of the protruding feature 106 to reach the read-write sensors 110, 112. The distal surface 124 is referred to as “above” or “located above” the air bearing surface 104 or actuated portion 138, without regard to the spatial orientation of the head 100. The “thickness” or “height” of the protruding feature 106 is the perpendicular distance from the actuated portion 138 of the air bearing surface 104 to the distal surface 124.

As illustrated in FIG. 9F, during contact detection, one or more of heater 140, 142, 144, 146 are activated until a actuated portion 138 of the air bearing surface 104 contacts the surface 126 of the lubricant 118. The surface area of distal surface 124 of the protruding feature 106 is very small compared to the area of the actuated portion 138, causing no practical interfacial lubricant interactions, even after penetrating the lubricant 118. It is important to note at this juncture, that to avoid burnishing of the protruding feature 106, the air bearing must be capable of following the disk waviness of the magnetic media 114, as described in U.S. Pat. No. 6,989,967 (Pendray et al.). In embodiments where the height of the protruding feature 106 is equal or smaller than the thickness of the lubricant 118 and the air bearing is adequate to follow the waviness of the magnetic media 114, burnishing of the protruding feature 106 is minimized.

After completing the contact detection process the protruding feature 106 has a height 108 above the actuated portion 138 of the air bearing surface 104 about the same as lubricant 118 thickness. The present embodiment contrasts with the prior art practice of using the active clearance 152 as the only reliability buffer. The illustrated embodiment uses both the clearance 152 and feature clearance 154 as the reliability buffer, with minimal lubricant induced modulation. Feature clearance 154 is the distance between distal end 124 of the protruding feature 106 and surface of carbon overcoat 116 on magnetic media 114. Since the read-write sensors 110, 112 can be located in a variety of locations within the protruding feature 106, the active clearance 152 is effectively decoupled from HMS 155. The HMS 155 is thus reduced while the same or similar active clearance 152 is maintained.

In essence, the protruding feature 106 permits the locations of the read-write sensors 110, 112 to be decoupled from the location of the air bearing surface 104. In order to do so, however, the protruding feature 106 preferably does not prevent the contact detection process. Otherwise, the locations of the read-write sensors 110, 112 will be in doubt and read-write operations compromised.

The reduction in HMS 128 arises from the fact that in the prior art the active clearance 120 was equal to the feature clearance 122. That is, the distal end 124 of the protruding feature 106 was maintained 25 Angstroms above the surface 126 of the lubricant 118. As illustrated in FIG. 9F, however, the feature clearance 154 is less than the active clearance 152. The protruding feature 106 extends into the active clearance 152, and in some instances into the lubricant 118. The protruding feature 106 preferably has a height that permits the contact detection process and a cross-sectional size that minimizes disturbances and lubricant interactions.

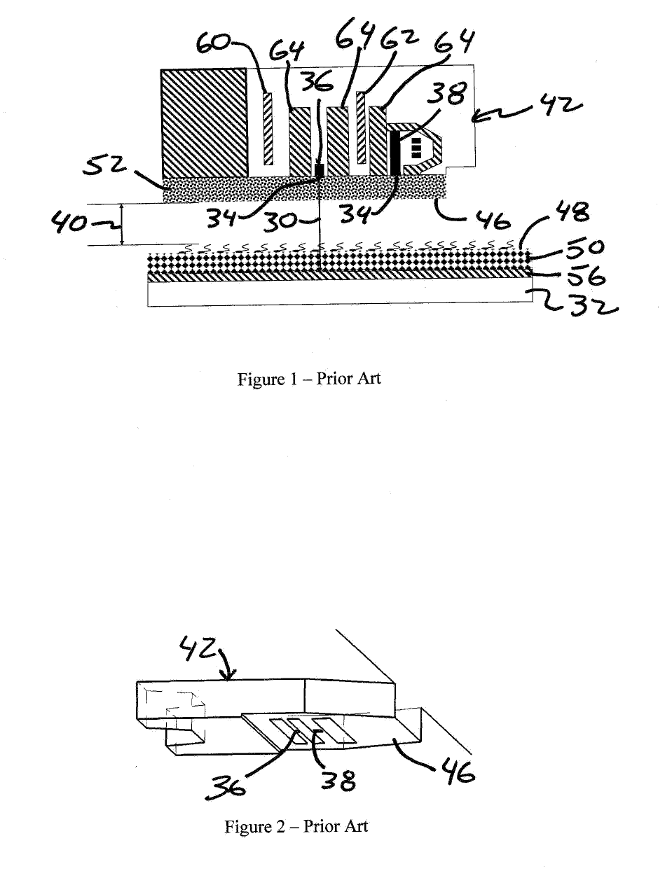

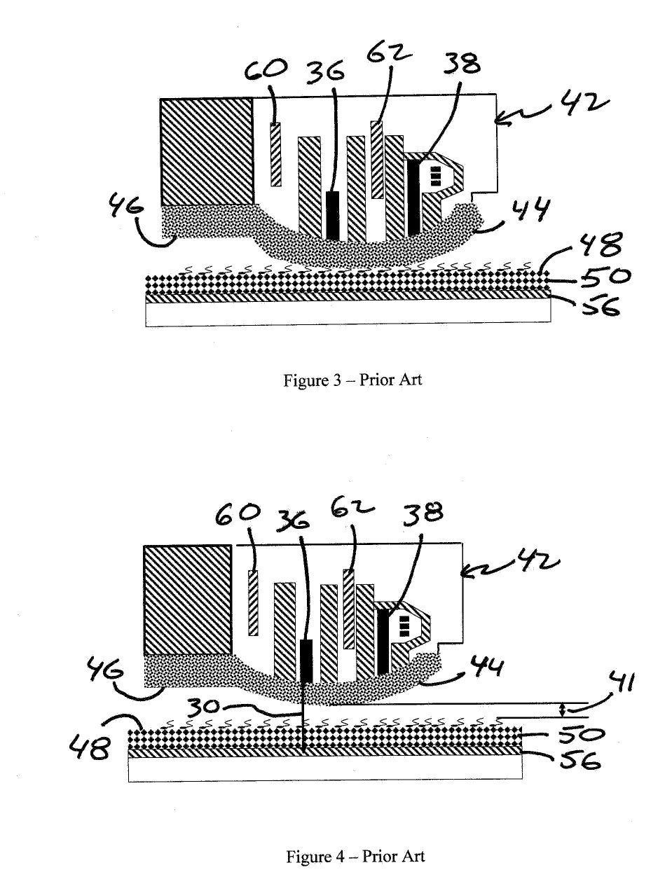

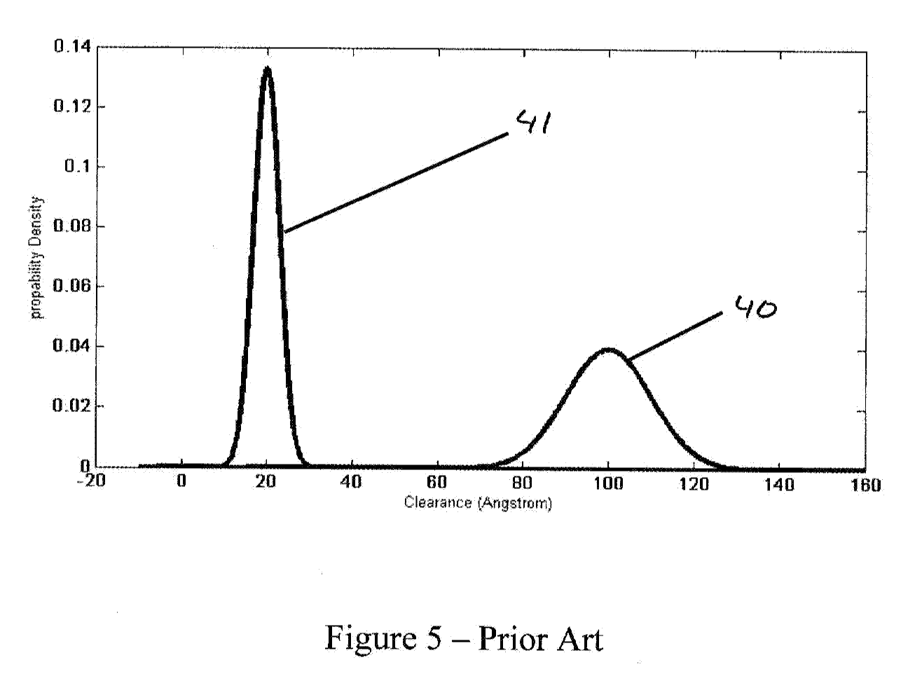

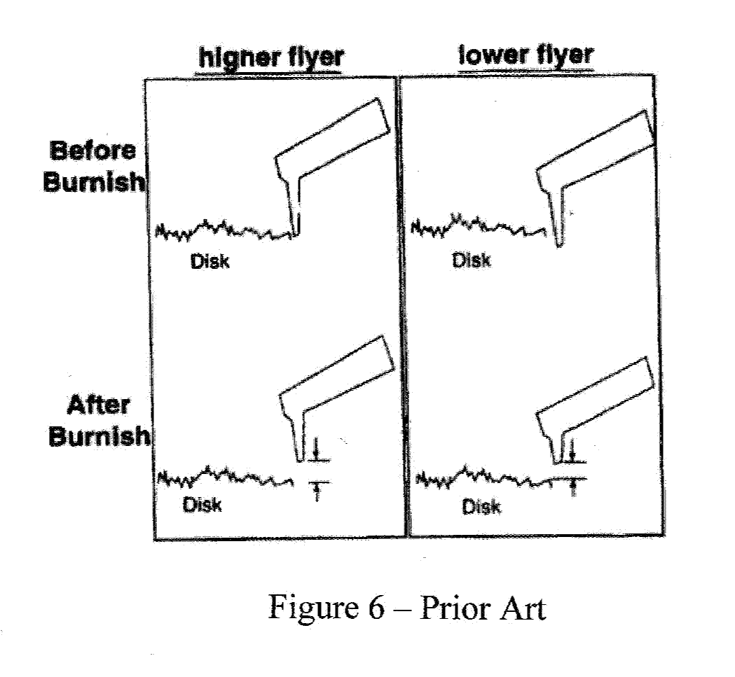

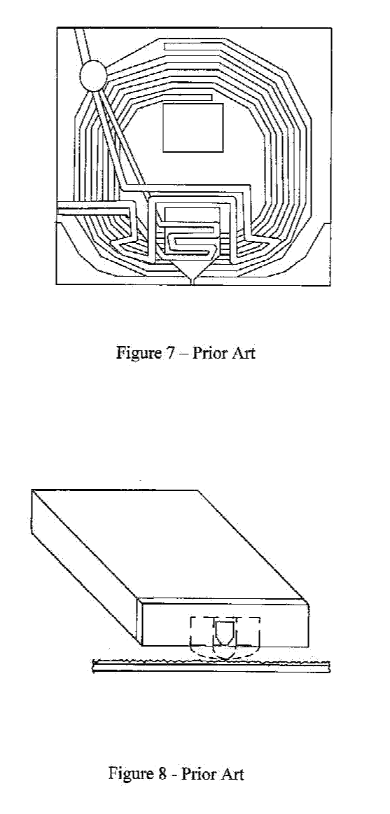

By way of example only, the carbon overcoat thickness 102 is about 15 Angstroms and the protruding feature 106 has a height of about 15 Angstroms. The lubricant layer 118 and carbon overcoat 116 on the magnetic media 114 are maintained at 15 and 25 Angstroms, respectively, as discussed above. If the active clearance 152 is maintained at about 25 Angstroms, the overall HMS 128 is reduced by about 15 Angstroms relative to the prior art embodiment of FIG. 1.

Since the active clearance 152 is maintained at about 20 Angstroms to about 25 Angstroms, the air bearing is very stable. It is likely, however, that the distal end 124 will penetrate into the lubricant layer 118. In order to minimize the transfer of lubricant 118 to the read-write heads 110, 112 and off-track motion, the area of distal surface 124 is preferably extremely small relative to the area of the actuated portion 138 of the air bearing surface 104. For example, a typical actuated portion is about 100 microns by about 10 microns, or 1,000 microns². The exposed surface 124 of the protruding feature 106, by comparison, is preferably less than about 100 microns² for the distal surface 124. Consequently, the exposed surface 124 is preferably less than 10% of the surface area of the actuated portion 138 of the air bearing surface 104.

In one embodiment, the exposed surface 124 of the protruding feature 106 is less than about 50 microns². Consequently, the exposed surface 124 is preferably less than about 5% of the surface area of the actuated portion 138 of the air bearing surface 104. In another embodiment, the exposed surface 124 of the protruding feature 106 is less than about 10 microns² or less than about 1% of the surface area of the actuated portion 138. In yet another embodiment, the exposed surface 124 of the protruding feature 106 is less than about microns² or less than about 0.1% of the surface area of the actuated portion 138.

Using the head-lubricant interfacial meniscus force equation discussed above (F=2 gA/h), where g is about 22 microNewton meters; h is about 25 Angstroms; A is the area of the exposed surface 124, in this example about 16 microns² (e.g., 4 microns×4 microns) the interfacial force generated if the protruding feature 106 is immersed in the lubricant layer 114, is about 28.2 microNewtons meters, compared to an interfacial force of about 176 microNewton meters generated if the actuated portion 138 engages with the lubricant layer 118. In this example, the interfacial force created by the protruding feature 106 is about 16% of the interfacial force created by the actuated portion 138.

When the protruding feature 106 is engaged with the lubricant, the signal modulation is preferably less than about 20 percent, and more preferably less than about 10 percent, to avoid read and write signal modulation failures. Signal modulation is a standard measure of signal integrity in disk drives. As used herein, “signal modulation” refers to a variation in a periodic waveform generated by a read-write sensor in a magnetic disk drive indicative of vibration or off-track motion. These levels of signal modulation have been found to be acceptable for conventional read write operations.

FIG. 9C illustrates the probable value of the passive clearance 120 for a group of heads 100 before contact detection. After contact detection, the active clearance 152 (see FIG. 9F) is set between about 10 Angstroms and about 30 Angstroms, where about zero Angstroms is defined by surface 126 of the lubricant 118. The distribution of the feature clearance 154 after contact detection (see FIG. 9F) is also shown in FIG. 9C. Some portion of the protruding features 106 penetrate the surface 126 of the lubricant 118 during disk operation.

FIG. 9D graphically simulates the actuated portion 138 of the air bearing surface 104 before contact detection and after contact detection. Before contact detection, the air bearing surface 104 is generally flat. After contact detection, the actuated portion 138 of the air bearing surface 104 exhibits a generally elliptical deformation due to heat supplied by heater 166. After contact detection, the actuated portion 138 of the air bearing surface 104 displaces the protruding feature 106 closer to the magnetic media 114.

FIG. 9E shows a three dimensional view of the actuated portion 138 of the air bearing surface 104 during normal read and write operations. It is noted that FIGS. 9A and 9F are not to scale and that FIGS. 9D and 9E provide a more realistic view of the aspect ratio of the protruding feature 106 relative to the actuated portion 138.

As best illustrated in FIG. 9B, the protruding feature 106 has a generally rectangular cross-section, rather than square. In one embodiment, the protruding feature 106 is oriented so that the narrower side 168 acts as the leading edge, further reducing the interfacial forces generated when traveling through the lubricant 118. The cross sectional shape of the protruding feature 106 can be rectangular, elliptical, triangular, teardrop, or a random shape to further lower the interfacial forces with the lubricant and optimize the clearance of the heat activated shape. The shape of the protruding feature can also be designed to match the shape of the protruded trailing edge area due to heating. The most likely scenario is an elliptical shape to minimize the clearance loss.

The leading edge 168 of the protruding feature 106 also engages with the lubricant layer 118 during rotation of the magnetic media 114. The protruding feature 106 is preferably about 15 Angstroms (0.0015 microns) high. Assuming for example that the exposed surface 124 of the protruding feature 106 is about 10 microns×10 microns, the surface area of the leading edge 168 is only 0.015 microns² (0.0015 microns×10 microns), which is a fraction of the surface area of exposed surface 124.

FIG. 9G is a schematic illustration of a magnetic disk drive 170 with the magnetic head 100 according to an embodiment of the present invention. The magnetic disk drive 170 includes a magnetic disk 172 rotated by a spindle motor 174, and the magnetic head slider 100 supported by a suspension 176 and flies along the surface of the magnetic disk 172. The positioning of the magnetic head slider 100 is accomplished by rotational driving of the suspension 176 by an actuator 180. As described herein, the magnetic head slider 100 containing one or more heaters 140, 142, 144, 146 proximate read-write sensors 110, 112 can control active clearance 152 independent of the HMS 128. (See FIG. 9A). When the read-write operation by the magnetic disk drive 100 is being interrupted or stopped for a definite time, the actuator 180 unloads the magnetic head slider 100 onto a ramp mechanism 182.

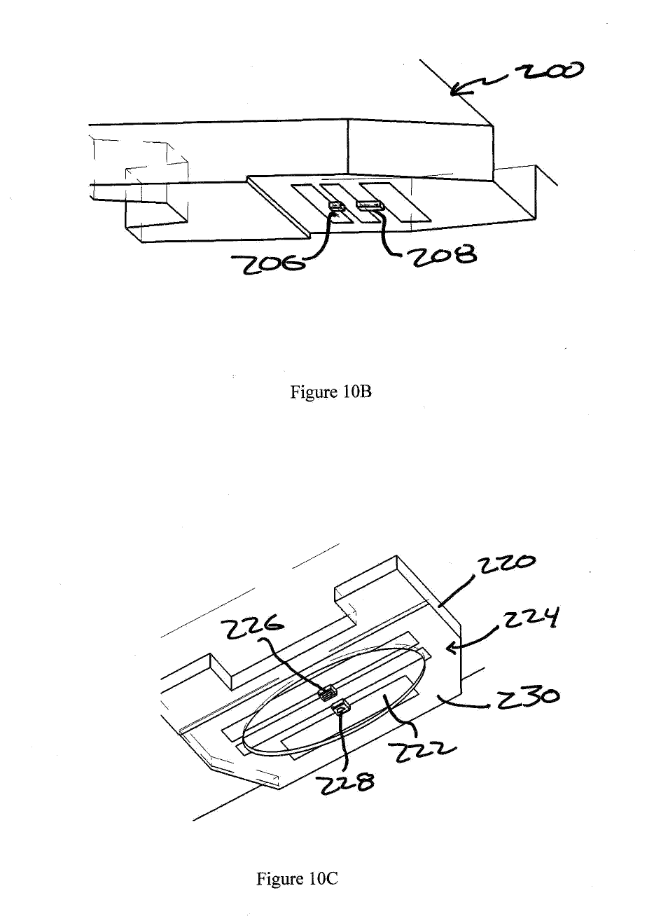

FIGS. 10A and 10B illustrate an alternate read-write head 200 in accordance with an embodiment of the present invention. The read-write head 200 is substantially the same as the read-write head 100 of FIG. 9A, except that separate protruding features 206, 208 protecting read-write sensors 210, 212, respectively. The combined area of distal surfaces 214, 216 of the protruding features 206, 208 is preferably less than about 100 microns² and more preferably less than about 50 microns². The protruding features 206, 208 are preferably constructed from diamond-like carbon.

FIG. 10C is a schematic illustration of a variation of the read-write head 200 of FIG. 10A. The read write head 220 includes a recessed actuated portion 222 on air bearing surface 224 surrounding protruding feature 226, 228 in accordance with an embodiment of the present invention. In the embodiment of FIG. 10C, the diamond-like carbon is removed from the air bearing surface 224 only in the portion 222 near the protrusions 226, 228. During the contact detection process, the actuated portion 222 is thermally expands above the level of the un-actuated portion 230 of the air bearing surface 224. Consequently, the un-actuated portion 230 of the air bearing surface 224 receives substantially the same thickness of carbon overcoat as the protruding features 226, 228. FIG. 10C can be manufactured by initially applying a uniform carbon overcoat thickness on the entire air bearing surface 224. The actuated portion 222 is then etched away, creating the protruding features 226, 228.

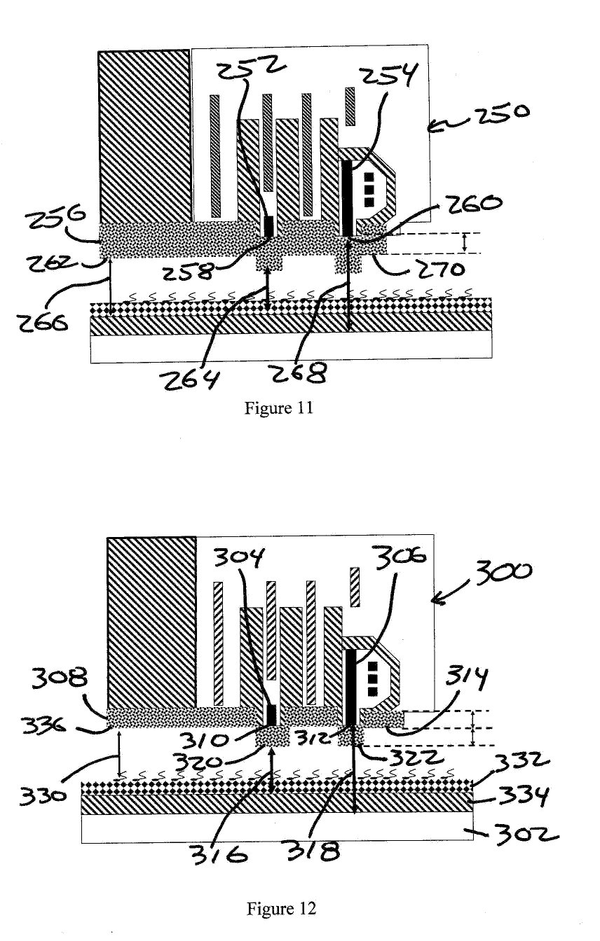

FIG. 11 illustrates an alternate read-write head 250 in accordance with an alternate embodiment of the present invention. One or both of the read-write sensors 252, 254 protrude into the carbon overcoat 256. Distal end 258, 260 of the read-write sensors 252, 254 are located behind the plane of the actuated portion 270 of the air bearing surface 262. Actuated portion 270 is shown at the same level as the remainder of the air bearing surface 262 for the sake of clarity. The feature clearance 264 is generally the same as in the embodiment of FIG. 9A. If the clearance 266 is maintained at about 25 Angstroms, the overall HMS 268 can be reduced by 15 Angstroms, without the use of secondary heaters.

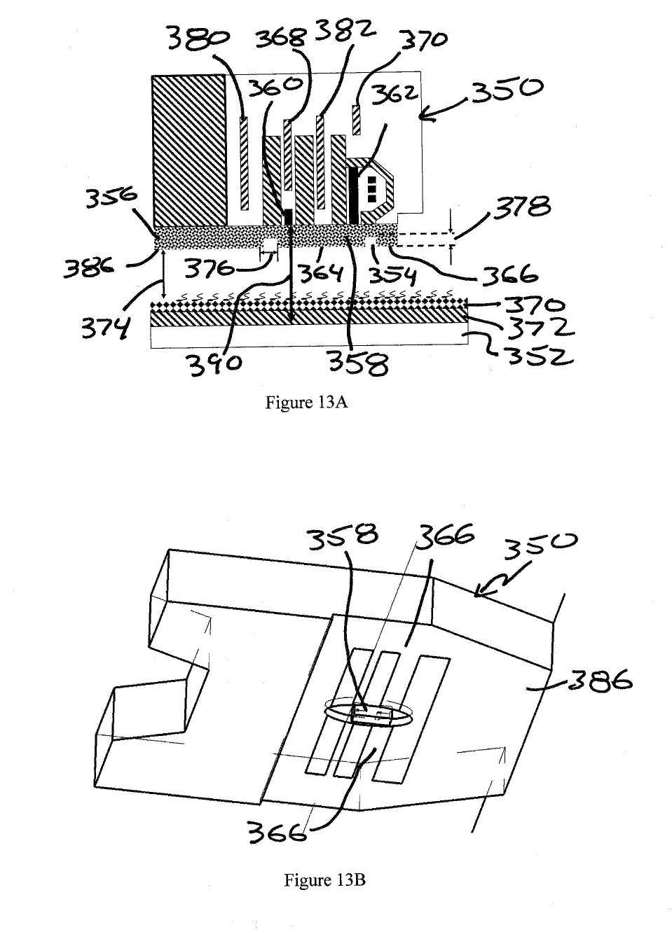

FIG. 12 is a cross-sectional view read-write head 300 relative to magnetic media 302 in accordance with an alternate embodiment of the present invention. FIG. 12 illustrates read-write sensors 304, 306 protruding into the base carbon overcoat 308 so distal ends 310, 312 of one or more of the read-write sensors 304, 306 are at about the same level as actuated portion 314 of air bearing surface 336. Actuated portion 314 is shown at the same level as the remainder of the air bearing surface 366 for the sake of clarity.

While the feature clearance 316 is generally the same as in the embodiment of FIG. 11, the HMS 318 is reduced by the amount the distal ends 310, 312 protrudes into the carbon overcoat 308, and in some embodiments, into the protruding features 320, 322. Due to the large difference in surface area of exposed surfaces 324, 326 of the protruding features 320, 322 compared to the surface 310, 312, it is assumed that protruding features 320, 322 about 15 Angstroms thick are adequate to protect the read-write sensors 304, 306 from both corrosion and wear.

Assuming the clearance 330 is maintained at about 25 Angstroms, lubricant layer 332 about 15 Angstroms, and carbon overcoat 334 at about 25 Angstroms, the overall HMS 318 can be reduced to about 65 Angstroms. In the event that the 15 Angstroms thick protruding features 320, 322 provides inadequate protection against corrosion, the disk drive can optionally be located in an oxygen-free environment.

Further reduction in HMS can be achieved by increasing the lubricant thickness to offset a reduction in carbon thickness. For example, an increase of about 4-5 Angstroms in lubricant thickness can yield about 10 Angstroms reduction in carbon overcoat on the magnetic media.

In another embodiment, the thickness of the lubricant layer 332 is increased and the thickness of the carbon overcoat 334 on the magnetic media 302 is reduced. The reduction in carbon overcoat 334 can be greater than, less then, or equal to, the increase in lubricant layer 332. This configuration allows the protruding features 320, 322 to have a thickness greater than 15 Angstroms, without increasing HMS 318. For example, if the lubricant 322 is increased to 25 Angstroms and the carbon overcoat 334 is reduced to 15 Angstroms, the thickness of the protruding features 320, 322 can be increased to 25 Angstroms while maintaining the HMS 318 at about 65 Angstroms, without the use of secondary heaters.

A variety of manufacturing process can be used to create the protruding features disclosed herein, including additive and/or subtractive processes, such as for example etching. It is also possible to create a separate protruding feature to protect both the read sensor and the write sensor.

### Dynamic Carbon Overcoat Feature

The introduction of one or more secondary thermal actuators to promote thermal actuation of a relatively small area becomes very challenging due to the thermal issues associated with the heater design and controlling the flow of heat across the entire air bearing surface. The prior art teaches using a relatively large secondary heater (see Burbank et al., 2007/0035881) thermal actuator to avoid the reliability issues associate with a micro heater. The large heaters of Burbank, however, cause material diffusion, melt down of the conductors, and reduced life of the read-write sensors. The practical and physical limitation of thermal diffusion dictates a relatively large protrusion area that will cause a significant interfacial force at the onset of lubricant interaction.

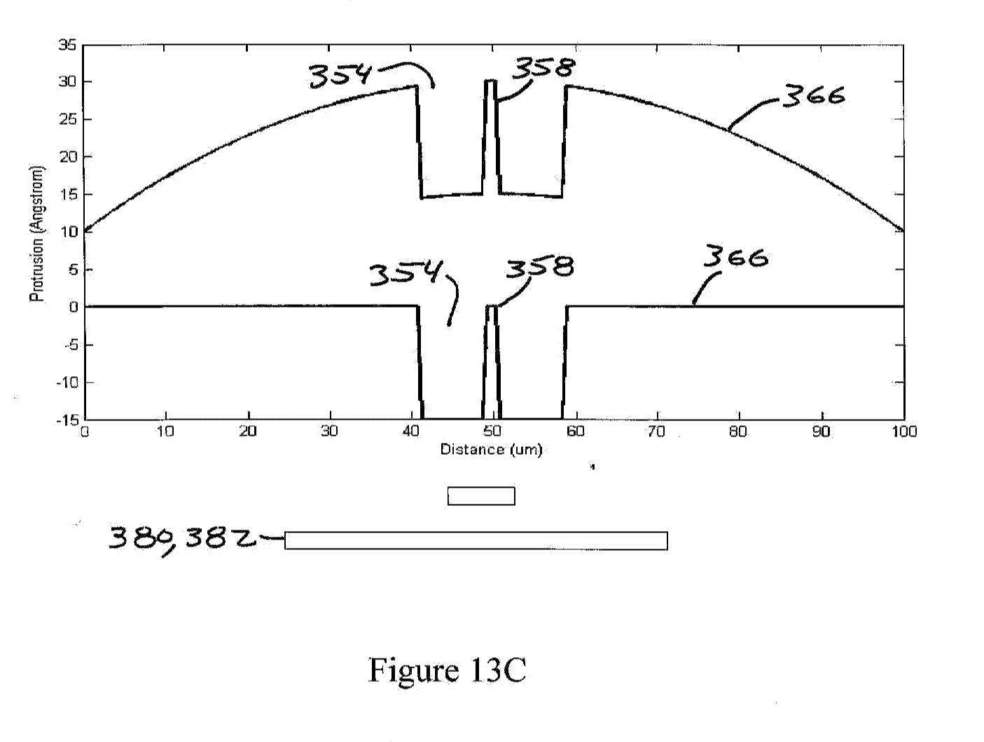

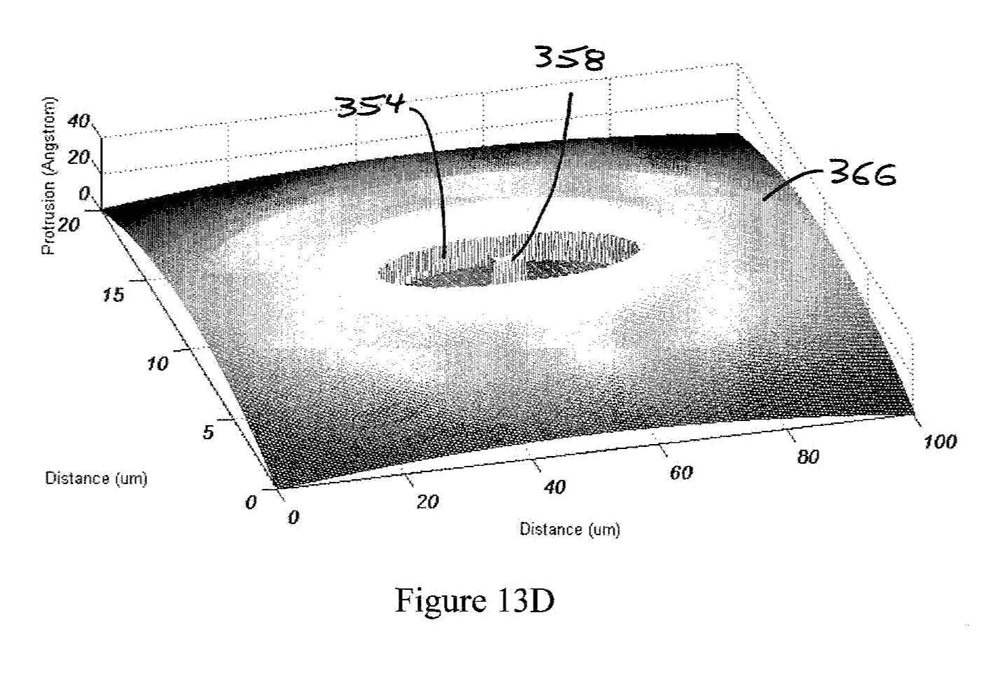

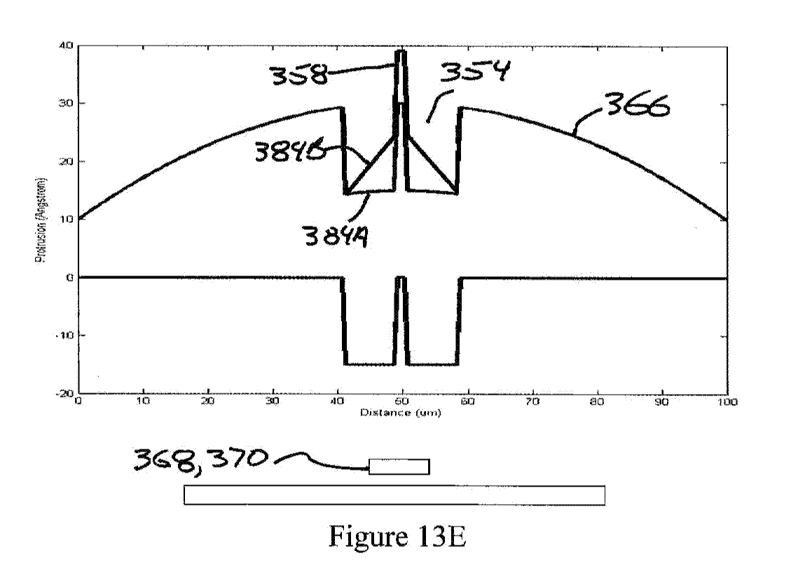

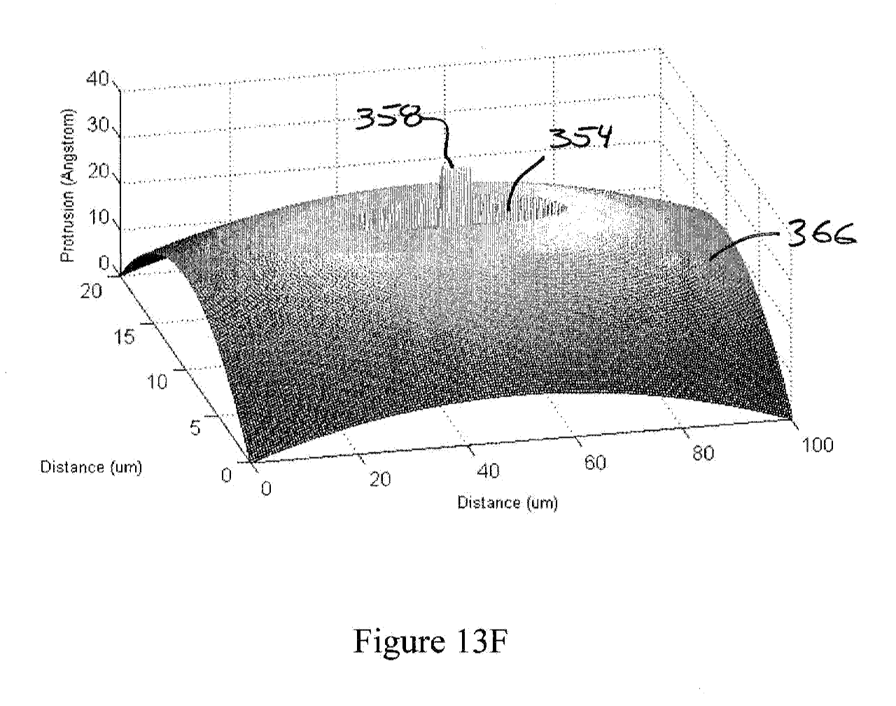

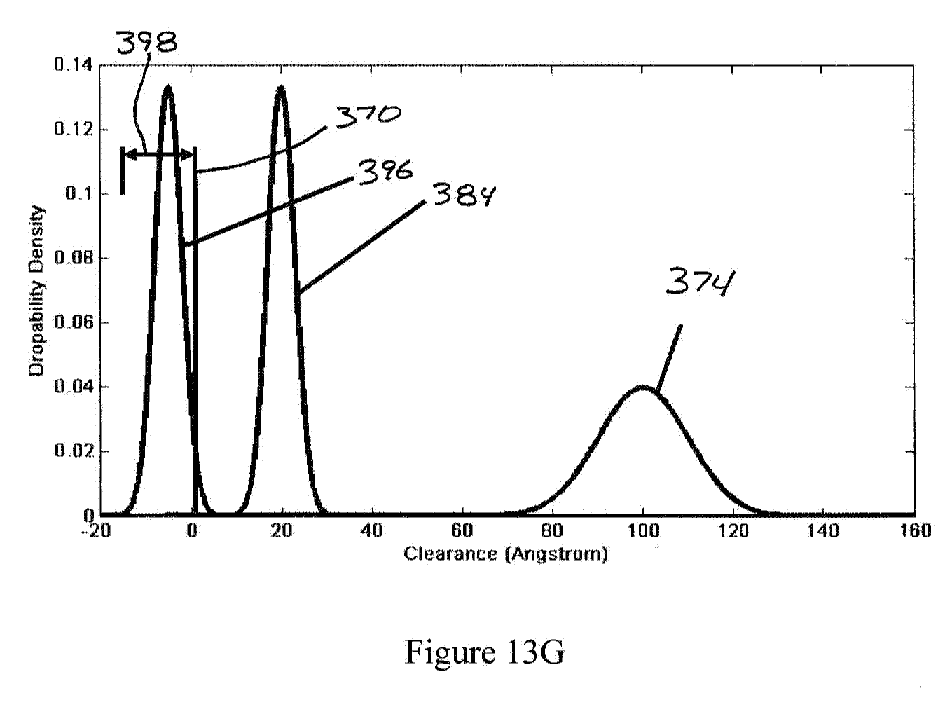

FIGS. 13A and 13B illustrate a cross-sectional view of a read-write head 350 relative to magnetic media 352 in accordance with another embodiment of the present invention. Pressure relief 354 is formed in carbon layer 356, preferably by etching. The resulting protruding feature 358 covers read-write sensors 360, 362. In the illustrated embodiment, distal end 364 of the protruding feature 358 is generally at the same level as actuated portion 366 of air bearing surface 386 prior to activation of one or more secondary heaters 368, 370. As used herein, “pressure relief” refers to one or more recesses, slots, notches, cuts, depressions or other features that concentrate thermal expansion in one or more protruding features. A pressure relief can be symmetrical or asymmetrical with respect to a protruding feature. A pressure relief can be oriented concentrically or radially with respect to the protruding feature. A pressure relief may optionally be used in combination with a thermal break and/or thermal insulators that slow the flow of heat from the protruding feature to adjacent regions of the air bearing surface.

By way of example only, the carbon overcoat 356 and the protruding feature 358 are each about 15 Angstroms thick. Lubricant layer 370 and carbon overcoat 372 on the magnetic media 352, and active clearance 383 between the actuated portion 366 and the lubricant layer 370 (see FIG. 13E) have the thicknesses discussed above. The pressure relief 354 has a width 376 of about 10 microns to about 20 microns and a depth 378 of about 15 Angstroms (measured generally perpendicular to the actuated portion 366). In an embodiment where the relief 358 is elliptical, the major axis is about 15 microns to about 30 microns and the minor axis is about 5 microns to about 15 microns.

FIG. 13C shows the actuated portion 366 of the carbon layers 356 and protruding feature 358 both before and after application of heat from one or more primary heaters 380, 382. The primary heaters 380, 382 provide generalized heating to thermally extend the actuated portion 366 toward the magnetic media 352 during contact detection and setting the active clearance 383. The actuated portion 366 is typically elliptically shaped after setting the active clearance 383.

The protruding feature 358 and the relief 354 are rigidly attached to the air bearing surface 386 and experience generally the same amount of displacement toward the magnetic media 352 as the actuated portion 366. In the embodiment of FIG. 13C, the secondary heaters 368, 370 are not activated. FIG. 13D is a three dimensional view of the deformation of the actuated portion 366 due to one or more of the primary heaters 380, 382. The relative size of the protruding feature 358, the relief 354, and the actuated portion 366 are also shown.

FIG. 13E shows the effect of one or more secondary heaters 368, 370 on the protruding feature 358. The size, shape, and location of the relief 354 confines base 384A of the relief 354 preferably below the level of the actuated portion 366 during actuation of the protruding feature 358 by one or more secondary heaters 368, 370. After activation of one or more secondary heaters 368, 370, the base 384B expands toward the magnetic media 352, but preferably does not extend above the actuated portion 366 of the air bearing surface 386. In one embodiment, the relief 354 permits the secondary heaters 368, 370 to be smaller than the primary heaters 380, 382, minimizing temperature increase of the carbon overcoat 356 adjacent to the protruding feature 358.

The relief 354 minimizes thermal expansion of the carbon overcoat 356 due to heat from the secondary heaters 368, 370. The relief 354 also allows for larger and more practical secondary heaters 368, 370, with minimal or no thermal expansion of the actuated portion 366 into the active clearance 383. The relief 354 reduces the effects of self compensation during the actuation of the secondary heaters 368, 370. Self compensation refers to a total change of active clearance 383 due to activation of one or more secondary heaters.

Small changes in active clearance 383 due to activation of one or more secondary heaters 368, 370 can be neutralized by developing a transfer function between the change in active clearance 383 versus secondary heater actuation using Wallace's equations. For example, the power to one or more primary heaters 380, 382 can be reduced to reduce the active clearance 383 to compensate for the effects of one or more secondary heaters 368, 370.

In the illustrated embodiment, the application of one or more primary heaters 380, 382 and one or more secondary heaters 368, 370 causes the relief 354 and protruding feature 358 to expand an additional 15-30 Angstroms above the actuated portion 366. The read-write sensors 360, 362 are now 15-30 Angstroms closer to the magnetic media 352, reducing the HMS 390 (see FIG. 13A) by that amount, without reducing the active clearance 383 necessary for a stable air bearing.

In the embodiment of FIG. 13A, one or more primary heaters 380, 382 are used to provide a contact detection signal with the lubricant 370, while one or more secondary heaters 368, 370 are designed to actuate the read-write sensors 360, 362 toward the magnetic media 352. The illustrated design is capable of a total deflection of about 40 Angstroms without excessive thermal increase at the HMI. The protruding feature 358 is able to penetrate the lubricant layer 370 and reduce HMS 390, without the penalty of modulation or lubricant transfer and without reducing the active clearance 383 important to a stable air bearing.

FIG. 13F depicts a three dimensional view of the configuration shown in FIG. 13E. In the illustrated embodiment, the relief 354 around the protruding feature 358 is generally elliptical in shape. Application of the secondary heaters 368, 370 extends the protruding feature 358 above the actuated portion 366. It is noted that FIG. 13A is not to scale and FIG. 13F provides a better perspective of the relative size of the protruding feature 358 and the actuated portion 366.

FIG. 13G illustrates the probable passive clearance 374 for a distribution of heads 350 before contact detection. The active clearance 383 of the heads 350 after contact detection is also shown. The group of heads 350 exhibit an active clearance 383 of between about 10 Angstroms and about 30 Angstroms. Curve 396 shows the probable distribution of feature clearances after activation of one or more secondary heaters 368, 370. The protruding features 358 likely penetrate the lubricant 370. In the illustrated embodiment, the active clearance 383 remains substantially unchanged after activation of one or more secondary heaters 368, 370. That is, the secondary heaters 368, 370 move the read-write sensors 360, 362 closer to the magnetic media 352, without compromising the active clearance 383.

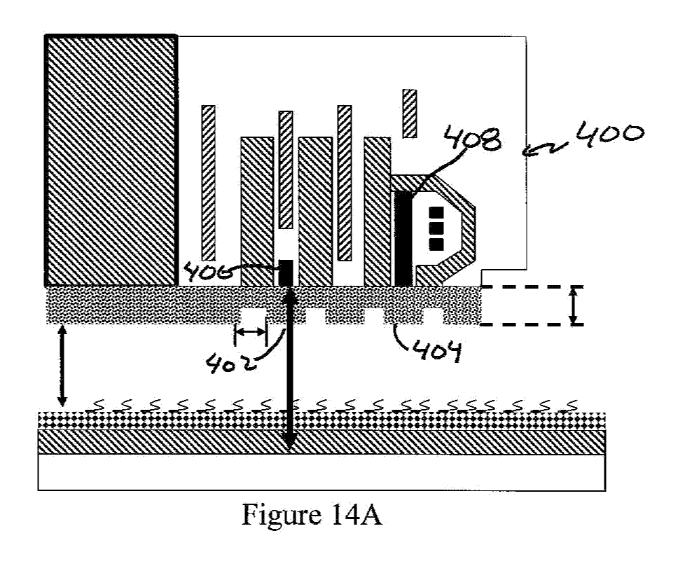

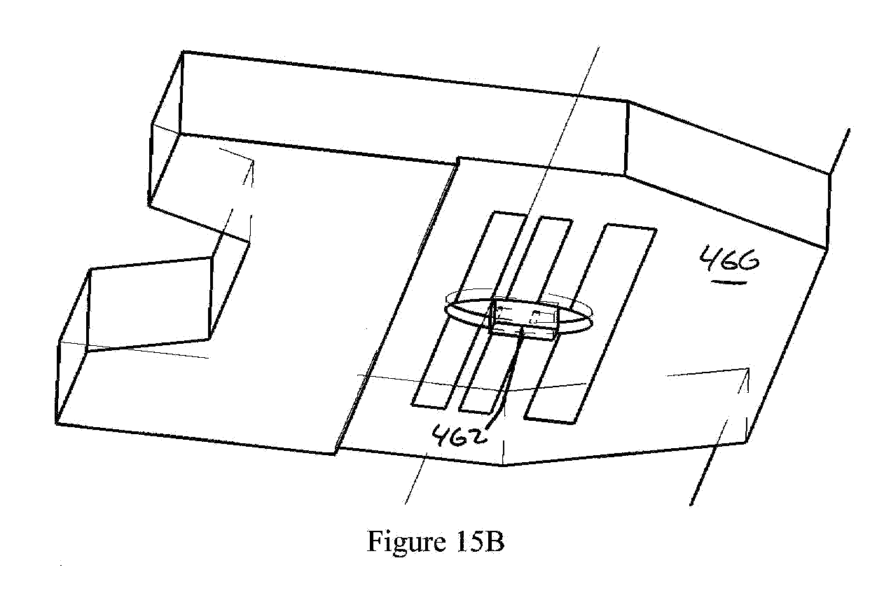

FIGS. 14A and 14B illustrate an alternate read-write head 400 in accordance with an embodiment of the present invention. The read-write head 400 is substantially the same as the read-write head 350 of FIG. 13A, except that separate protruding features 402, 404 protecting read-write sensors 406, 408, respectively.

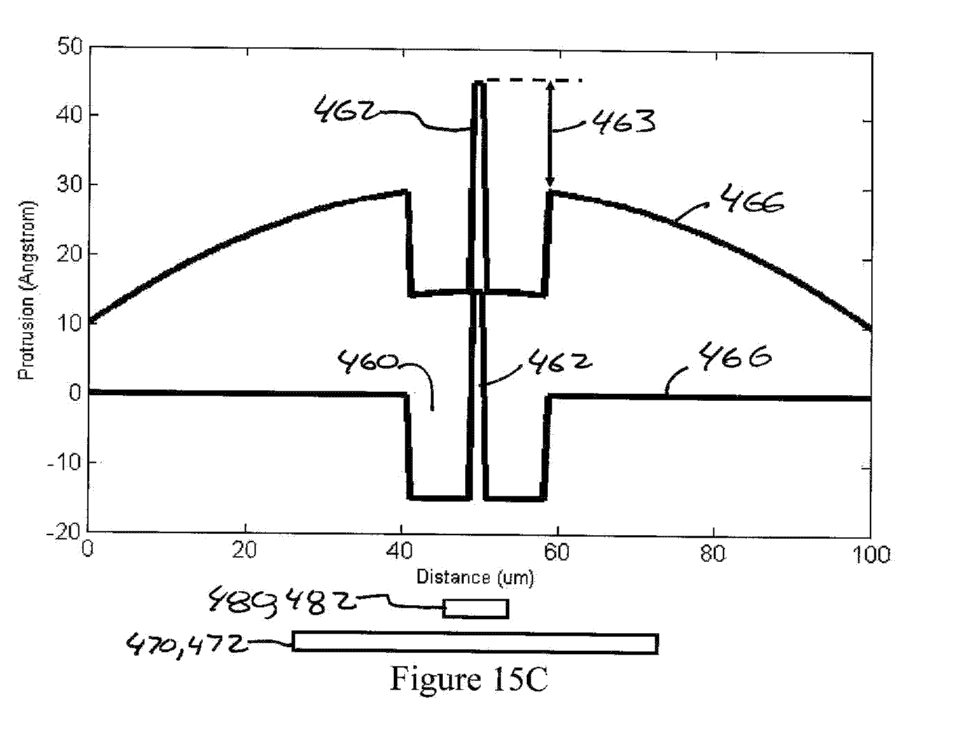

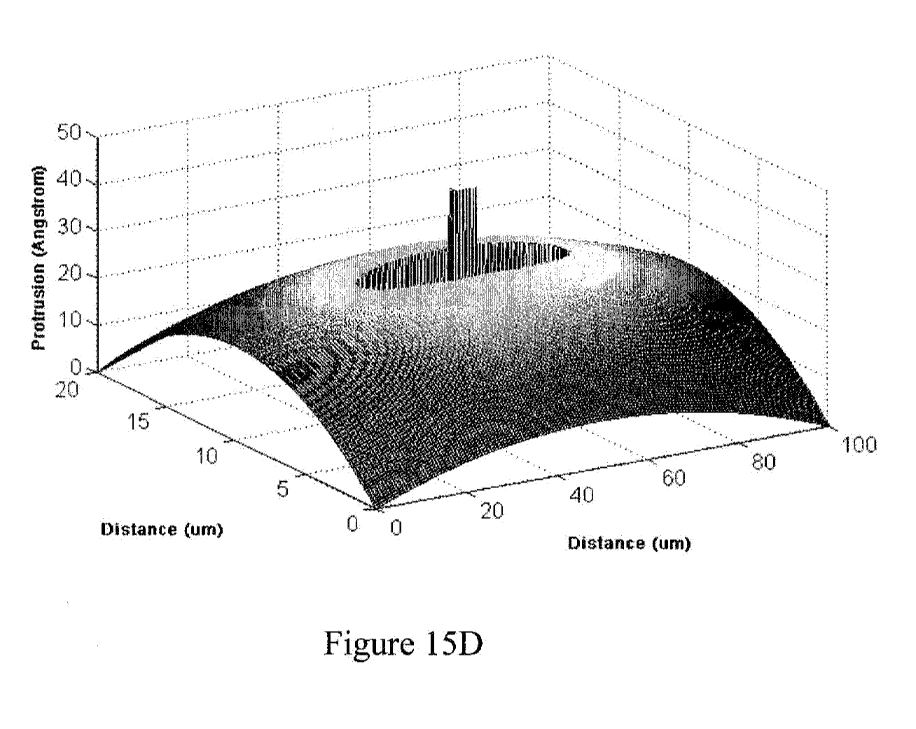

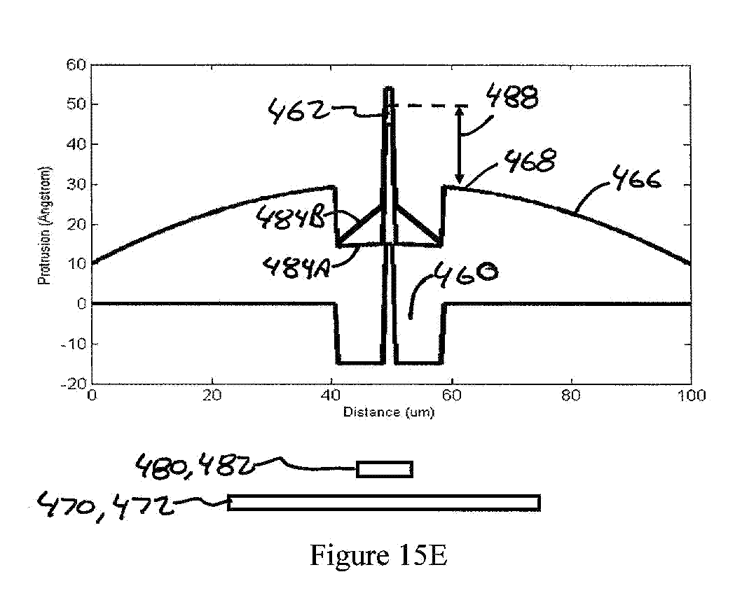

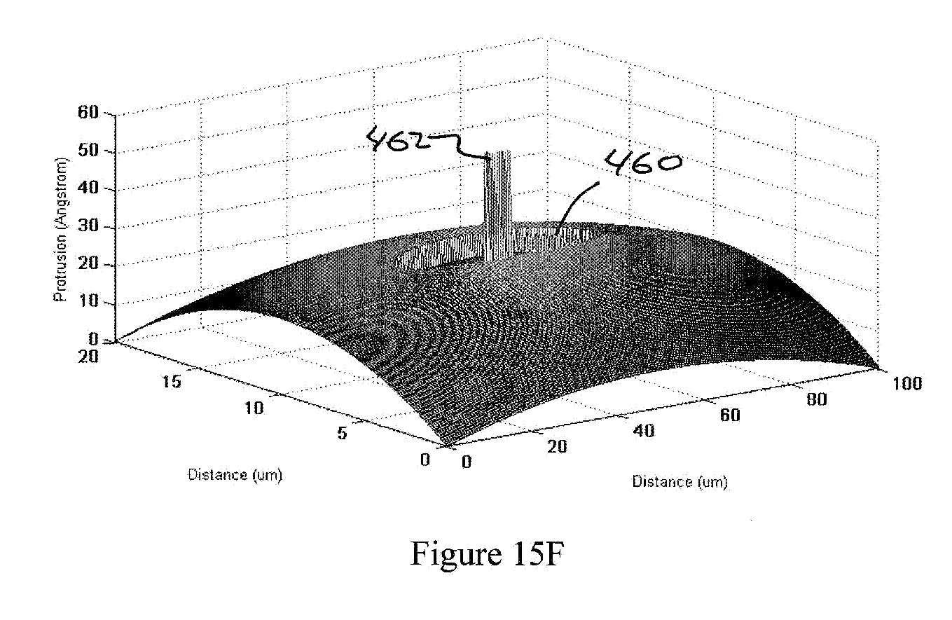

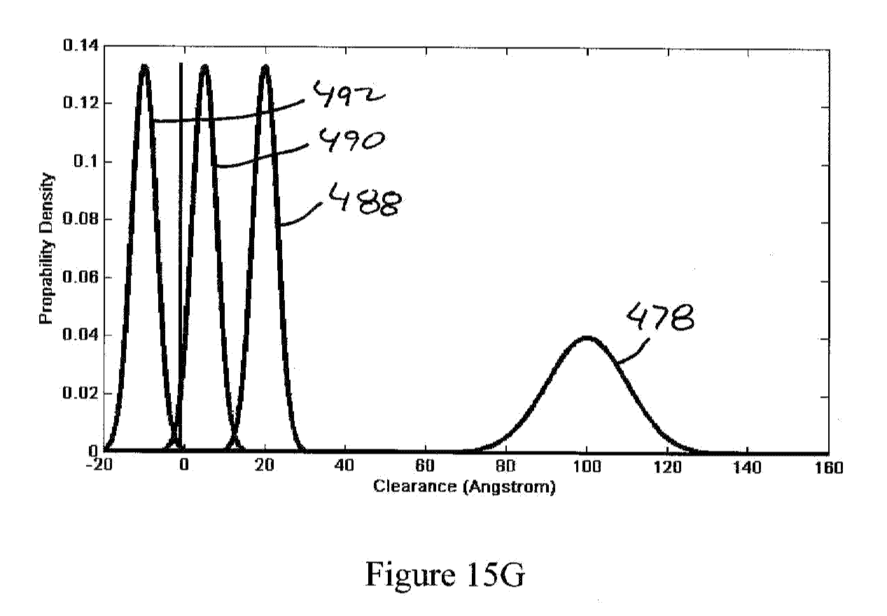

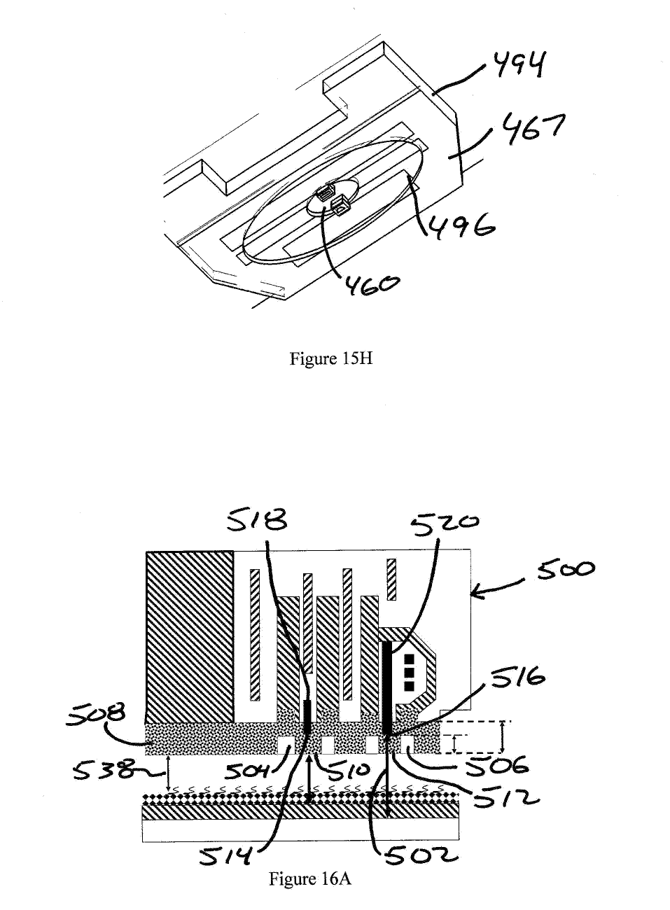

FIGS. 15A and 15B illustrate an alternate read-write head 450 in accordance with another embodiment of the present invention. FIG. 15A illustrates a cross-sectional view of the HMS 452 of read-write sensors 454, 456 relative to magnetic media 458. Pressure relief 460 extends around protruding feature 462. Distal surface 464 of protruding feature 462 extends above actuated portion 466 of air bearing surface 467 even before activation of any heaters. Base layer 468 of carbon overcoat provide corrosion protection, while protruding feature 462 located in front of read-write sensors 454, 456 provides wear protection. The protruding feature 462 is preferably made entirely of diamond-like carbon.

By way of example only, the base layer 468 is about 15 Angstroms thick, while the protruding feature 462 is about 30 Angstroms thick. The protruding feature 462 extends about 15 Angstroms above the actuated portion 466 before activation of primary heaters 470, 472. Lubricant layer 474 and carbon overcoat 476 over the magnetic media 458, and active clearance 488 (see FIG. 15E) have the thicknesses discussed above.

FIG. 15C schematically represents the actuated portion 466 and the protruding feature 462 both before and after activation the contact detection procedure. One or more primary heaters 470, 472 thermally deform the actuated portion 466. In the embodiment of FIG. 15C, secondary heaters 480, 482 are not yet activated.

In one embodiment, secondary heaters 480, 482 are not required. Heat from the primary heaters 470, 472 thermally deforms both the actuated portion 466 and increases the height 463 of the protruding feature 462. The height 463 of the protruding feature 466 above the thermally deformed actuated portion 466 is preferably less than or equal to the thickness of the lubricant layer 474 so as to not interfere with the contact detection process. Alternatively, the height 463 is less than about 25% greater than the thickness of the lubricant layer 474.

FIG. 15D is a three dimensional view of the deformation due to one or more primary heaters 470, 472 during contact detection. The relative size of the protruding feature 462, the relief 460, and actuated portion 466, are best illustrated in FIG. 15D.

FIG. 15E shows the effect of one or more secondary heaters 480, 482 on the protruding feature 462. The size, shape, and location of the relief 460 confines base 484A of the relief 460 preferably below the actuated portion 466 during actuation of the protruding feature 462 by one or more secondary heaters 480, 482. After activation of one or more secondary heaters 480, 482, the base 484B expands toward the magnetic media 458. Note that the carbon overcoat 468 adjacent to the relief 460 is subject to minimal thermal expansion from the secondary heater 480, 482 because of the gap created by the relief 460.

In the illustrated embodiment, the application of one or more primary heaters 470, 472 and one or more secondary heaters 480, 482 cause the relief 460 and protruding feature 462 to deform about an additional 5-30 Angstroms above the actuated portion 466. The read-write sensors 454, 456 are now about 5-30 Angstroms closer to the magnetic media 458, reducing the HMS 452 by that amount, without reducing the active clearance 488 necessary for a stable air bearing. In the present embodiment, the HMS 452 is in the range of about 60 Angstroms to about 65 Angstroms.

FIG. 15F depicts a three dimensional view of the configuration shown in FIG. 15E. In the illustrated embodiment, the relief 460 is generally elliptical in shape. As discussed above, the location of the protruding feature 462 relative to the magnetic media 458 is decoupled from the active clearance 488, with a reduction in HMS 452 of about 35 Angstrom without reducing carbon overcoat and lubricant thickness on the critical features, or lowering the active clearance necessary for a stable air bearing.

FIG. 15G illustrates the probable passive clearance 478 of a distribution of heads 450 before contact detection. The active clearance 488 of the heads 450 after contact detection is also illustrated. The group of heads 450 exhibit an active clearance 488 of the actuated portion 466 relative to the surface of the lubricant 474 of between about 10 Angstroms and about 30 Angstroms. Curve 490 shows the distribution of the protruding features 462 extending above the actuated portion 466 before activation of one or more secondary heaters 480, 482.

Curve 492 shows a distribution of the active clearance of the protruding features 462 extending above the actuated portion 466 after activation of one or more secondary heaters 480, 482. Most of the protruding features 462 are located in the lubricant 474 (see also, FIG. 15E). In the illustrated embodiment, the active clearance 488 remains substantially unchanged after activation of one or more secondary heater 480, 482. Consequently, the air bearing is sufficiently stable to perform read-write operations without significant modulation, even with the protruding feature 462 located in the lubricant 474.

FIG. 15H is a schematic illustration of a variation of the read-write head 450 of FIG. 15A. The read-write head 494 includes a recessed actuated portion 496 in the air bearing surface 467. Note that pressure relief 460 associated with the secondary heaters 480, 482 is located in the actuated portion 496. The air bearing surface 467, the actuated portion 496 and the pressure relief 460 are all located at different levels.

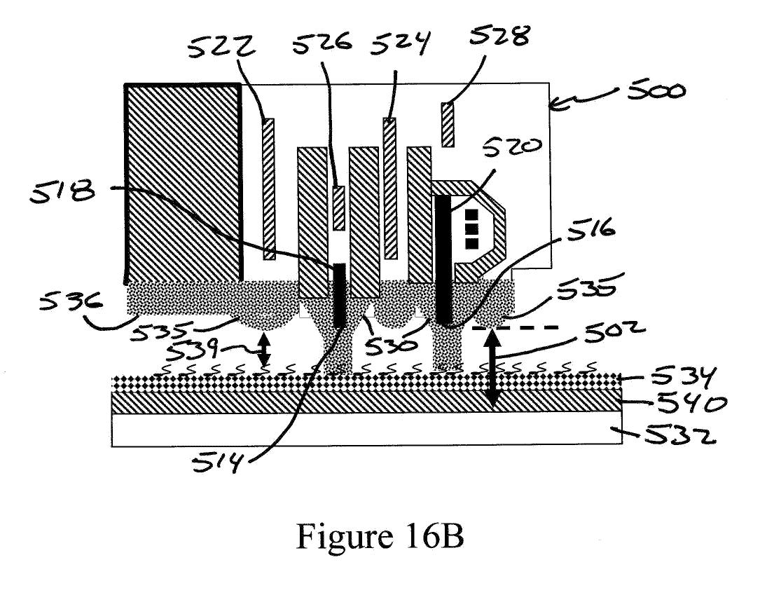

FIG. 16A illustrates a cross-sectional view of the HMS 502 of read-write head 500 in accordance with another embodiment of the present invention. Pressure relief 504 and 506 are formed in base layer 508 of carbon overcoat to define protruding features 510, 512. Distal ends 514, 516 of the read-write sensors 518, 520 extend into the protruding features 510, 512, respectively.

FIG. 16B illustrates a cross-sectional view of the write head 500 after contact detection with one or more primary heaters 522, 524 and one or more secondary heaters 526, 528 activated. Bases 530 of the pressure relief 504 and 506 thermally deform to advance the distal ends 514, 516 of the read-write sensors 518, 520 toward the magnetic media 532. The protruding features 510, 512 extends into lubrication layer 534.

In the embodiment of FIG. 16B, the distal ends 514, 516 of the read-write sensors 518, 520 optionally extend above the plane of the actuated portion 535 of the air bearing surface 536. For example, in an embodiment where the read-write sensors 518, 520 extend about 5 Angstroms above the actuated portion 535, HMS 502 spacing is reduced by that amount, without changing the active clearance 539. In an embodiment where the active clearance 539 is maintained at about 25 Angstroms, the read-write sensors 518, 520 are only about 20 Angstroms above the lubricant layer 534. Adding a lubricant layer 534 of about 15 Angstroms and a carbon overcoat 540 of about 25 Angstroms, the HMS 502 is about 60 Angstroms.

By way of example only, if the lubricant layer 534 is increased from about 15 Angstroms to about 25 Angstroms, the carbon overcoat 540 on the magnetic media 532 can be reduced from about 25 Angstroms to about 15 Angstroms, resulting in a HMS 502 of about 55 Angstroms, thus permitting a data density of about 2 Tbit/in².

Further reductions in HMS can be realized by reducing the environmental losses in the disk drive due to temperature, humidity and altitude. Sensors can optionally be added to the disk drive to compensate for temperature changes, humidity changes and altitude changes, as done in commercially available disk drives.

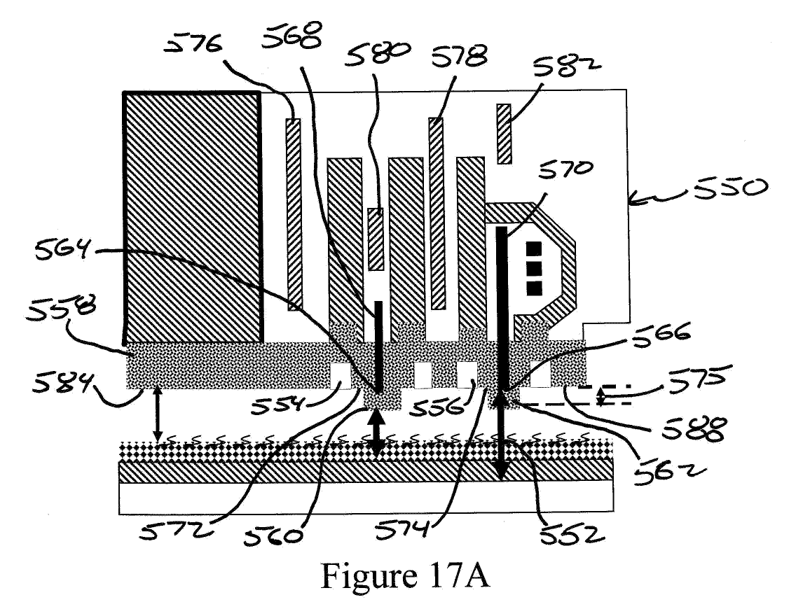

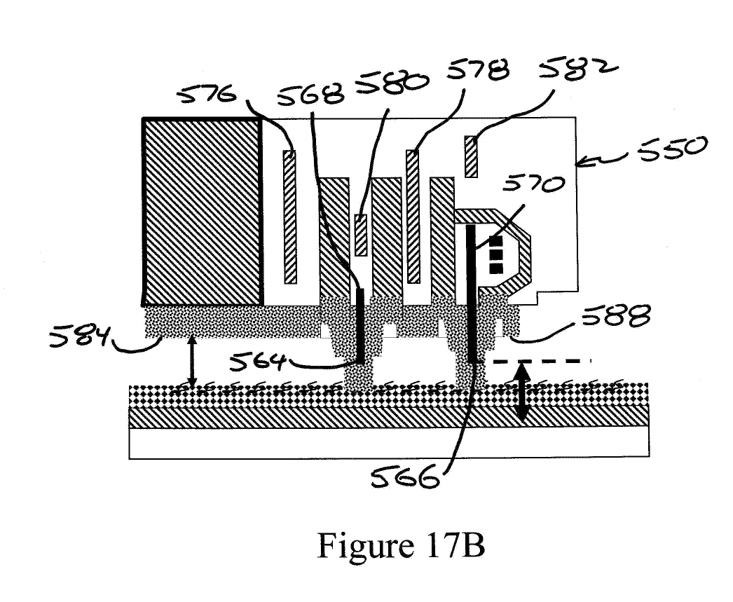

FIG. 17A illustrates a cross-sectional view of the HMS 552 of read-write head 550 in accordance with another embodiment of the present invention. Pressure reliefs 554 and 556 are formed in base layer 558 of carbon overcoat to define protruding features 560, 562. Distal ends 564, 566 of the read-write sensors 568, 570 extend into the protruding features 560, 562 to about the level of the air bearing surface 584. The protruding features 560, 562 include a stepped portions 572, 574, respectively, that extend an amount 575 above the actuated portion 588 of the air bearing surface 584. The actuated portion 588 is shown at the same level as the air bearing surface 584 for the sake of simplicity.

FIG. 17B illustrates a cross-sectional view of the write head 550 after contact detection with one or more primary heaters 576, 578 and one or more secondary heaters 580, 582 activated. In the embodiment of FIG. 17B, the distal ends 564, 566 of the read-write sensors 568, 570 extend well above the plane of the air bearing surface 584, to provide a HMS 586 of about 60 Angstroms.

Where a range of values is provided, it is understood that each intervening value, to the tenth of the unit of the lower limit unless the context clearly dictates otherwise, between the upper and lower limit of that range and any other stated or intervening value in that stated range is encompassed within the inventions. The upper and lower limits of these smaller ranges which may independently be included in the smaller ranges is also encompassed within the inventions, subject to any specifically excluded limit in the stated range. Where the stated range includes one or both of the limits, ranges excluding either both of those included limits are also included in the inventions.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described. All patents and publications mentioned herein, including those cited in the Background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

What is claimed is:

1. A slider for use in a data storage system having a rotating magnetic media with a lubricant layer on a media surface, the slider comprising:
a slider body comprising at least one read-write sensor and an air bearing surface that causes the slider to fly above a lubricant surface at a first distance;
at least a first actuator adapted to thermally induce expansion in the slider body so an actuated portion of the air bearing surface contacts a lubricant surface during a contact detection process, wherein the slider flies above the lubricant surface at a second distance less than the first distance after the contact detection process; and
at least one protruding feature generally covering the read-write sensors, the protruding feature comprising a distal surface generally opposite the media surface with an area of less than about 100 microns and a height above the actuated portion of the air bearing surface after the contact detection process less than or equal to a thickness of the lubricant layer.

2. The slider of claim 1 wherein the protruding feature comprises a height above the air bearing surface before the contact detection process less than, greater than, or equal to the thickness of the lubricant layer.

3. The slider of claim 1 wherein the protruding feature comprises a height about 25% greater than the thickness of the lubricant layer before the contact detection process.

4. The slider of claim 1 wherein the protruding feature comprises a height generally equal to a height of the air bearing surface before the contact detection process.

5. The slider of claim 1 comprising at least one secondary actuator adapted to induce thermal expansion of the protruding feature without substantial thermal deformation of the actuated portion of the air bearing surface adjacent to the protruding feature.

6. The slider of claim 5 comprising a HMS of less than about 70 Angstroms after activation of the secondary actuator.

7. The slider of claim 1 comprising at least one pressure relief located proximate the protruding feature.

8. The slider of claim 1 comprising at least one pressure relief located between the protruding feature and the actuated portion of the air bearing surface.

9. The slider of claim 1 wherein the actuated portion of the air bearing surface is recesses relative to an un-actuated portion of the air bearing surface.

10. The slider of claim 1 wherein the distal surface of the protruding feature comprises an area of less than about 5 micron².

11. The slider of claim 1 wherein the distal surface of the protruding feature comprises an area of less than about 5% of a surface area of the actuated portion of the air bearing surface.

12. The slider of claim 1 wherein the distal surface of the protruding feature comprises an area of less than about 1% of a surface area of the actuated portion of the air bearing surface.

13. The slider of claim 1 wherein the protruding feature comprises a cross-sectional that is one of rectangular, elliptical, triangular, teardrop, or random.

14. The slider of claim 1 comprising a HMS of less than about 75 Angstroms after the contact detection process.

15. The slider of claim 1 comprising a HMS of less than about 65 Angstroms after the contact detection process.

16. The slider of claim 1 wherein a signal modulation from the read-write sensors is less than 20% after the contact detection process.

17. The slider of claim 1 comprising a reliability buffer of air between the air bearing surface and the lubricant surface, and a reliability buffer of air and lubricant between the protruding feature and the media surface.

18. The slider of claim 1 wherein the protruding feature consists essentially of diamond-like carbon.

19. A data storage system comprising:
a rotating magnetic media with a lubricant layer on a media surface;
a slider body comprising at least one read-write sensor and an air bearing surface that causes the slider to fly above a lubricant surface at a first distance;
at least a first actuator adapted to thermally induce expansion in the slider body so an actuated portion of the air bearing surface contacts the lubricant surface during a contact detection process, wherein the slider flies above the lubricant surface at a second distance less than the first distance after the contact detection process; and
at least one protruding feature generally covering the read-write sensors, the protruding feature comprising a distal surface generally opposite the media surface with an area of less than about 100 microns² and a height above the contacting portion of the air bearing surface after the contact detection process less than or equal to a thickness of the lubricant layer.

20. A method for use in a data storage system, comprising the steps of:
locating a slider body comprising at least one read-write sensor above a rotating magnetic media having a lubricant layer on a media surface, the slider body including at least one protruding feature generally covering the read-write sensor;
generating an air bearing that causes the slider to fly above a lubricant surface at a first distance;
thermally expanding the slider body so an actuated portion of an air bearing surface contacts the lubricant surface during a contact detection process and the at least one protruding feature penetrates the lubricant layer;
reducing the thermal expansion of the slider body after the contact detection process so the slider flies above the lubricant surface at a second distance less than the first distance, and the protruding feature comprising height above the actuated portion of the air bearing surface after the contact detection process less than or equal to a thickness of the lubricant layer; and
writing data to the magnetic media.

21. The method of claim 20 comprising the step of thermally inducing expansion of the protruding feature using at least one secondary heater, without substantial thermal deformation of the air bearing surface adjacent to the protruding feature.

22. The method of claim 20 comprising the step of reducing thermal expansion of the slider body to compensate for a decrease in the second distance caused by activating the secondary heater.
